(19) United States
(12) Patent Application Publication
(10) Pub. No.: US 2025/0093257 A1
(43) Pub. Date: Mar. 20, 2025

(54) QUALIFICATION RATE INCREASING METHOD FOR FINISHED PRODUCTS BASED ON TRADEMARK PARAMETER DETECTION AND CONTROL

(71) Applicant: HONGYUN HONGHE TOBACCO (GROUP) CO., LTD., kUNMING (CN)

(72) Inventors: Jun Jiao, Kunming (CN); Hong Liang, Kunming (CN); Mingbing Yao, Kunming (CN); Jiandong Zhu, Kunming (CN); Yu Zhao, Kunming (CN); Bingtong Liu, Kunming (CN); Jinghui Cheng, Kunming (CN); Ling Ye, Kunming (CN); Jinglie Hao, Kunming (CN)

(21) Appl. No.: 18/967,716

(22) Filed: Dec. 4, 2024

Related U.S. Application Data
(63) Continuation of application No. PCT/CN2024/070627, filed on Jan. 4, 2024.

(30) Foreign Application Priority Data
Mar. 9, 2023 (CN) 202310223228.6

(51) Int. Cl. G01N 19/10; G01N 1/04; G01N 19/02

(52) U.S. Cl. CPC G01N 19/10; G01N 1/04; G01N 19/02

(57) ABSTRACT

A qualification rate increasing method for finished products based on trademark parameter detection and control is disclosed. Trademark parameters are detected and controlled at the front end of production. Specifically, according to the folding, gluing, and transportation stages of trademarks in a packaging machine, quality of a trademark gluing position is detected and controlled, trademark indentation stiffness is detected and controlled, and a trademark surface friction coefficient is detected and controlled, to determine the suitability of placing the trademarks on the machine to determine whether the trademarks meet production standards. Only a batch of trademarks of samples whose three detection results are all determined to be qualified can enter the production process, and trademark raw materials that do not meet the production standards are eliminated. Raw materials that may produce defect products are eliminated from the source.

### CROSS REFERENCE TO RELATED APPLICATIONS

The present application is a Continuation Application of PCT Application No. PCT/CN2024/070627 filed on Jan. 4, 2024, which claims the benefit of Chinese Patent Application No. 202310223228.6 filed on Mar. 9, 2023. All the above are hereby incorporated by reference in their entirety.

### TECHNICAL FIELD

The present invention relates to a tobacco trademark quality detection and control method, and in particular, to a qualification rate increasing method for finished products based on trademark parameter detection and control.

### BACKGROUND

With the competition in the market economy, people have higher and higher requirements for product packaging. Carton packaging with beautiful appearance and rich surface colors is often more attractive to consumers. With the application of high-tech achievements in cigarette packaging equipment, cigarette packaging equipment will develop in the direction of higher production forces, higher packaging quality, and higher intelligence. With the introduction of a large number of high-speed equipment, the requirements for roll packaging accessories are becoming higher and higher. Besides, trademarks are very important cigarette packaging materials, and the quality of various trademark indicators directly affect the operation of the equipment and the quality of cigarette products. With the development of cigarette packaging equipment, subject to a series of problems such as production, quality, and consumption, it will become increasingly important to improve the suitability of placing trademarks on machines. In the cigarette industry, pack packaging and carton packaging are collectively referred to as trademarks. The process of processing trademarks into finished products in the packaging machine includes folding, gluing, bonding, and glue drying. Besides, the trademarks are continuously transferred through various stages in the packaging machine. There is constant friction between the trademark surface and the conveyor belt. Therefore, the folding effect of the trademark, the quality of the gluing position, and the friction coefficient of the trademark surface all affect the qualification rate of the finished trademark.

The trademark paper (cigarette carton packaging paper/cigarette packet packaging paper) needs to be indented so that the folded finished product is flatter and more beautiful. The die-cutting and indenting process uses steel wires to make impressions on paper or cardboard according to specifications, so that the paper or cardboard can be bent using this indentation to form a carton. Therefore, the folding effect of the trademark depends on the indentation stiffness. If the indentation stiffness does not meet the requirement, the folding effect of the trademark is poor, the bonding is unstable during gluing, and the gluing fails. This further causes defects such as the trademark is blocked in the packaging machine due to forming failure, the glue of the folded packaging packs cracks, the bottom is exposed after forming, closing is loose, and upper and lower widths are inconsistent. FIG. 4 and FIG. 5 are schematic diagrams of comparison between pack trademarks and carton trademarks that have appearance quality problems due to indentation stiffness quality defects and qualified products.

Trademark papers are network-like interwoven fabric formed by treatment of most natural fibers and fillers. The fiber material not only absorbs moisture from a humid gaseous environment, but also desorbs moisture to a dry gaseous environment. Moreover, the trademark paper fiber also has the characteristics of water absorption swelling and desorption shrinkage. When the air humidity is higher than the moisture contained in the paper, the trademark absorbs the moisture in the air and expands and elongates. Otherwise, the trademark desorbs the water and shrinks and becomes shorter, so as to achieve a relative moisture equilibrium state. Trademark gluing often uses white latex or hot melt glue for bonding and forming. White latex is obtained by emulsion polymerization using water as the dispersion medium, and is a water-soluble adhesive with the advantages of fast drying, good initial adhesiveness, good operability, strong adhesion, high compressive strength, and strong heat resistance. Therefore, the moisture adsorption and desorption capacity of the trademark, the gluing method, and the structure of the trademark bonding position all affect its bonding effect, cigarette pack forming quality, and the like. If the moisture adsorption rate of the trademark is too small, the glue has poor ductility and cannot be dispersed quickly; if the moisture adsorption rate is too high, the glue may soak through the paper, causing the trademark to adhere to the cigarette pack channel to cause jamming. If the moisture desorption rate is too small, the glue solidifies too slowly, and the bonding is unreliable; if the moisture desorption rate is too high, the glue solidifies too quickly, and the bonding is also unreliable. Therefore, if the trademark gluing effect cannot meet the standard, it causes problems such as poor forming, cracking of the packaging packs, and collapse of the packaging packs when packaging into the packs. This causes the equipment to jam, and more seriously, the packaging machine cannot package the trademark into shape. FIG. 2 and FIG. 3 are schematic diagrams of comparison between pack trademarks and carton trademarks that have appearance quality problems due to trademark gluing position quality defects and qualified products.

As for the friction coefficient of the surface of the trademark, if the friction coefficient is too large, it may cause the cigarette pack channel to be blocked; if the friction coefficient is too small, it may easily cause the trademark to slip in the material warehouse, causing the trademark unloading to be blocked and causing poor suitability of placing the material on the machine. Even if the trademark can be transported in the packaging machine, the friction does not meet the condition, resulting in that the residence time at each stage in the packaging machine does not meet the requirement. The abnormal residence time of the trademark in the gluing region may easily lead to gluing failure and the curling of the finished product, or the trademark is not conveyed smoothly in the packaging machine, resulting in skewed conveying and curling of the finished product. FIG. 6 and FIG. 7 are schematic diagrams of comparison between pack trademarks and carton trademarks that have appearance quality problems due to trademark surface friction coefficient quality defects and qualified products.

At present, quality detection almost always takes the formed cigarette packs as the object. Usually when problems are discovered, a large number of unqualified products and material waste have been caused. Besides, when defective products are found, a series of processes need to be completed to eliminate defective products, and the machine also needs to be shut down to check the reasons. While causing material waste, it also greatly reduces production efficiency and affects the entire industry chain. More seriously, it has caused packaging equipment to get stuck and shut down. Therefore, it is necessary to detect and control parameters of each batch of trademarks before actual production to improve the qualification rate of finished products.

### SUMMARY

In order to solve the above problems, the present invention provides a qualification rate increasing method for finished products based on trademark parameter detection and control. A batch of trademarks is sampled and the quality of the trademark gluing position, the trademark indentation stiffness, and the trademark surface friction coefficient are detected, then the suitability of placing the batch of trademarks on the machine is determined based on the detection result, and unqualified trademarks with poor machine suitability are then eliminated, to improve the qualification rate of finished products. Specifically, the purpose of the present invention is achieved as follows:

A qualification rate increasing method for finished products based on trademark parameter detection and control, including:
quality detection and control of a trademark gluing position, detection and control of trademark indentation stiffness, and detection and control of a trademark surface friction coefficient; where
the quality detection and control of the trademark gluing position includes pretreatment of a trademark gluing region and detection of trademark moisture adsorption and desorption capacity; and
when detecting trademark parameters, samples are taken from the same batch of trademarks, and the samples are evenly distributed and used to detect the trademark indentation stiffness, the trademark moisture adsorption and desorption capacity, and the trademark surface friction coefficient; only a batch of trademarks of samples whose three detection results are all determined to be qualified can enter a production process; otherwise, this batch of trademarks are eliminated.

Further, the trademark includes a pack trademark and a carton trademark; and the quality detection and control of the trademark gluing position includes the following steps:
S1: dividing the gluing region: dividing the trademark gluing region into a non-print surface gluing region and a print surface gluing region;
S2: pretreatment: pretreating the print surface gluing region to form a surface that is easy to absorb glue;
S3: detecting moisture adsorption and desorption capacity: separately detecting moisture adsorption and desorption capacity of the non-print surface gluing region and the print surface gluing region of the sample trademark; and
S4: performing quality determination: comparing detection data with an internal control range to determine whether the moisture adsorption and desorption capacity of the selected sample is qualified, and determining, based on a determination result, whether the moisture adsorption and desorption capacity of the gluing region of this batch of trademarks is qualified.

Further, the pretreatment of step S2 includes indentation treatment or scraping treatment of the print surface gluing region, so that the original smooth print surface gluing region forms an uneven surface to facilitate glue absorption; the indentation treatment includes forming indentation lines or indentation points in the print surface gluing region, the scraping treatment includes destroying the smooth surface of the print surface gluing region to form a hairy surface, and when performing indentation treatment or scraping treatment, the indentation line or indentation point or scraping density of a region close to a folding indentation position in the print surface gluing region is greater than that of other regions.

Further, step S3 of moisture adsorption and desorption capacity detection includes the following steps:
S3.1: sampling: selecting samples from the batch of to-be-detected trademarks, cutting and sampling non-print surface gluing regions and print surface gluing regions on the selected sample trademarks, to cut a to-be-detected part into 40 mm*40 mm samples, and placing the samples on a sample tray of a moisture adsorption and desorption detector, where a weight of the sample in each sample tray is controlled between 1.5 g and 3.5 g;
S3.2: performing stage treatment: performing stage treatment on the sample in the sample tray through the moisture adsorption and desorption detector; where the stage includes an equilibrium stage, a moisture absorption stage, and a dehumidification stage; and recording the mass of the sample at the end of each stage; and
S3.3: performing calculation: according to the recorded mass of the sample at the end of each stage, calculating sample mass change rates in the moisture absorption stage and dehumidification stage respectively, and using the results to represent a moisture absorption rate and a dehumidification rate of the sample respectively; where
in step S3.2, parameter values for the equilibrium stage are set to temperature 24° C., humidity 60%, and treatment time of 5 minutes; parameter values for the moisture absorption stage are set to temperature 24° C., humidity 90%, and treatment time of 60 minutes; and parameter values of the dehumidification stage are set to temperature 24° C., humidity 60%, and treatment time of 60 minutes;
in step S3.1, when the sampled region includes the two types of gluing regions at the same time, sampling is performed according to the print surface gluing region; and
in step S4, when the moisture adsorption or desorption capacity of the sample trademark is unqualified in detection data of the non-print surface gluing region or the print surface gluing region of the selected sample trademark, it is determined that the moisture adsorption and desorption capacity of the sample trademark is unqualified; and when the defect rate of moisture adsorption and desorption capacity of detection samples of this batch of trademarks accounts for 10% or more, it is determined that this batch of trademarks is unqualified.

Further, the trademark includes a pack trademark and a carton trademark; and the detection of the trademark indentation stiffness includes the following steps:
S1: establishing a to-be-detected indentation database: classifying the trademarks according to trademark size data of each specification and a process of packaging the trademarks into packs in the packaging machine; determining to-be-detected indentations on each category of trademarks and an internal control range of each to-be-detected indentation, and establishing a to-be-detected indentation database;
S2: sampling: cutting and sampling the to-be-detected indentation of the selected sample according to a specification of the batch of trademarks of the sample;
S3: performing stiffness detection: using a bending stiffness meter to detect stiffness of a selected indentation sample, comparing measured stiffness data with the internal control range, and determining whether the stiffness of the sample trademark indentation is qualified based on a comparison result; and
S4: performing quality determination: comparing based on the indentation stiffness measurement result of the sample trademark to determine whether the batch of trademarks of the sample meets the production requirement.

Further, when the to-be-detected indentation is sampled in step S2, a sample shape of the part cut from the indentation is a rectangle, the rectangle is divided into a bending length part and a clamping depth part with the part cut from the indentation as the boundary; the bending length part is a square with the part cut from the indentation as one side, the clamping depth part is a rectangle with the part cut from the indentation as a short side, a length ratio of the long side to the short side of the clamping depth part is two to one; when sampling the to-be-detected indentation in step S2, a region where the midpoint of the indentation is located is selected; if two indentations are too close to each other or sampling regions where the midpoints of the indentations are located at the same time causes overlap and conflict in sampling parts, regions where points in one-third positions at opposite ends of the two close indentations are located are respectively selected; and a length of the part cut when sampling the to-be-detected indentation is 6 mm.

Further, in step S4, all indentations are divided into a critical indentation group and a non-critical indentation group, indentations at gluing and folding positions and indentations at critical folding positions for cigarette pack forming belong to the critical indentation group, the remaining indentations belong to the non-critical indentation group, if the critical indentation group includes an indentation with stiffness exceeding an internal control range, it is determined that the trademark indentation stiffness quality fails, and if the non-critical indentation group includes more than two indentations with stiffness exceeding the internal control range, it is determined that the trademark indentation stiffness quality fails.

Further, the trademark includes a pack trademark and a carton trademark; and the detection of the trademark surface friction coefficient includes the following steps:
S1: determining a friction surface: according to contact with the packaging machine when the trademark is folded and passes through a packaging machine channel, dividing the trademark into a front surface, a back surface, a left side surface, and a right side surface;
S2: sampling: cutting the sample according to a to-be-detected surface;
S3: measuring a friction coefficient: using a friction coefficient meter to measure friction coefficients of the front surface, the back surface, the left side surface, and the right side surface of the sample trademark respectively; where the friction coefficient includes a static friction coefficient and a dynamic friction coefficient;
S4: comparing measurement results: comparing the detected friction coefficient with the internal control value to determine whether the sample friction coefficient meets the requirement; and
S5: performing quality determination: comparing based on the measurement result of the sample to determine whether the batch of trademarks of the sample meets the production requirement.

Further, the step S3 of measuring the friction coefficient includes the following sub-steps:
A: leveling: placing the instrument on a stable and vibration-free platform to adjust the level;
B: setting a slider weight: setting the slider weight on the instrument;
C: performing stroke setting: setting an instrument measurement stroke, where the default is 100 mm;
D: making a sample: pasting the cut-out trademark measurement part on the bottom surface of the slider, where the cut size is consistent with the size of the bottom surface of the slider;
E: performing detection zero adjustment: before starting the measurement, performing zero adjustment;
F: making sample preparation: fixing a measuring pad flatly on a horizontal detection bench, placing the measuring surface of the sample on the measuring pad downwards without impact, and hanging a traction rope to a sensor hook, so that the traction rope is in a horizontal and straight state, and the edge of the sample is parallel to the edge of the detection bench;
G: performing measurement: starting measuring after the sample is in contact with the measuring pad for 15 seconds, and measuring a dynamic friction and a static friction of the measurement sample respectively; and
H: performing calculation: dividing the measured static friction and dynamic friction by the normal force respectively to obtain the static friction coefficient and the dynamic friction coefficient; where
the traction rope includes a soft connection traction rope and a hard connection traction rope, a spring is provided in the middle of the soft connection traction rope, when measuring static friction, the soft connection traction rope is used, and when measuring dynamic friction, the hard connection traction rope is used; and
in step S4, if the detected friction coefficient of at least one of the front surface and the back surface of the sample is within the internal control value, and at least one of the left side surface and the right side surface is within the internal control value, it is determined that the friction coefficient of the sample meets the requirement; otherwise, it does not meet the requirement.

Further, in step B, different measuring sliders are used for different measurement surfaces of the trademark, when measuring the friction coefficient of the front surface or the back surface of the trademark, a large slider with a square bottom surface of 63 mm×63 mm and a weight of 1.949 N is used; when measuring the friction coefficient of the left side surface or the right side surface of the trademark, a small slider with a rectangular bottom surface of 19 mm×49 mm and a weight of 0.725 N is used; an ordinary A4 paper is selected as the measuring pad in step F, and the same batch of A4 papers is used to measure the same batch of trademarks, where each A4 paper is used for only one-time detection, and a new unused A4 paper needs to be used for each detection.

Further, samples selected to detect the indentation stiffness and the moisture adsorption and desorption capacity of the trademark are placed in an environment with a temperature of 22° C.±1° C. and a relative humidity of 60%±5% for twenty-four hours before the detection.

The working principle of the present invention is as follows:

Since the use of ink for print patterns has an impact on the trademark surface, the trademark is divided into a print surface gluing region and a non-print surface gluing region during gluing. The print surface gluing region is shown in FIG. 8. The non-print surface gluing region is shown in FIG. 9 and FIG. 10. Before gluing, the print surface gluing region is pretreated to form a rough surface that is easy to absorb glue. The pretreated trademarks are sampled according to different gluing regions to detect the moisture adsorption and desorption capacity, so that the detection results are more accurate. Based on the detection results, the raw materials of the trademarks can be better screened and controlled, and unqualified trademarks can be eliminated. This method makes the raw material trademarks more suitable to the gluing, drying, conveying and packaging processes on the packaging machine, and reduces the defect rate of finished products. When detecting the moisture adsorption and desorption capacity, the production environment is first simulated and the sample is placed in a specific temperature and humidity environment for equilibrium to make the sample more representative. The detection is divided into an equilibrium stage, a moisture absorption stage, and a dehumidification stage; the equilibrium stage synchronizes the samples to the same level, and then the adsorption rate and the desorption rate are detected respectively to make the detection results more accurate.

The trademark indentation stiffness affects the effect of folding the trademark into a pack and the bonding effect after folding the trademark. Too strong stiffness may cause the glue to crack; and too weak stiffness may cause the pack to collapse. These problems cause the trademark to get stuck in the packaging machine or the finished product to become defective, requiring the machine to be shut down for treatment or defective products to be eliminated. Therefore, it is necessary to determine the indentations on the trademark that affect the folding effect, and then divide the indentations into the critical group and the non-critical group according to the trademark positions of the indentations and the function of each indentation, and then sample the indentations separately. When sampling, a region of the middle of the indentation is selected as much as possible to make it more representative and increase accuracy. If two indentations are too close, regions where one-third positions at opposite ends of the two close indentations are located are respectively selected to achieve the purpose of balancing the detection data. Then, a bending stiffness meter is used to measure the stiffness of the indentation on the trademark. The stiffness of each indentation is compared with the internal control range. When determining whether the trademark indentation stiffness is qualified, there are different determination criteria for the two groups to improve the accuracy of the determination of qualified trademarks and unqualified trademarks and avoid unnecessary elimination and waste. After sampling and before detecting, the samples are placed in an environment with a relative controlled temperature and humidity for equilibrium, to fully simulate the production environment, making the detection results more consistent with the actual production environment and increasing measurement accuracy. There are a wide variety of trademarks, and various types of trademarks have differences in indentation stiffness due to differences in sizes or printed patterns on the print surfaces. Therefore, trademarks are divided into categories to determine the internal control ranges to further improve detection accuracy.

The contact surfaces between the trademark and the machine channel that generate friction during the cigarette production and transportation process are different. The trademark surface friction coefficient affects the friction generated. The trademark needs to be folded into a pack in the packaging machine. After gluing, drying, and other steps, different surfaces of the trademark rub against the channel when the trademark is transported through the channel. Each surface of the trademark has a different printed pattern and a different area. Therefore, when measuring the trademark surface friction coefficient, the trademark needs to be divided into the front surface, the back surface, the left side surface, and the right side surface. When the cigarette pack on the packaging machine is about to move but has not yet moved, the force between the cigarette pack and the contact surface is static friction. When the cigarette pack moves during the packaging process, the interaction force between the cigarette pack and the contact surface is dynamic friction. Both states appear in the production process; therefore, it is necessary to measure whether the static friction and the dynamic friction meet the internal control range to determine the suitability of placing the trademark on the machine. When measuring the dynamic friction of a trademark, if the traction rope is a soft connection traction rope 106, it causes the slider 103 to bounce during measurement, affecting the accuracy of the detected coefficient. Therefore, when measuring dynamic friction, it needs to be replaced with a hard connection traction rope 105.

The beneficial effects of the present invention are as follows:

1. Trademark parameters are detected and controlled at the front end of production. Specifically, according to the folding, gluing, and transportation stages of trademarks in a packaging machine, quality of a trademark gluing position is detected and controlled, trademark indentation stiffness is detected and controlled, and a trademark surface friction coefficient is detected and controlled, to determine the suitability of placing the trademarks on the machine to determine whether the trademarks meet production standards. Trademark raw materials that do not meet the production standards are eliminated. Raw materials that may produce defect products are eliminated from the source. There is no need to start shutdown check to eliminate defective products only when a problem occurs in the quality detection step of finished products or the production process. This avoids waste of production materials and greatly improves production efficiency. After using this method, the overall defect rate in the production factory drops by about 51.72% in a single day; and the defect rate caused by unqualified trademarks decreases by about 32.32%, which effectively reduces the defect rate of finished products, saves a series of supporting materials, and improves production efficiency.

2. When detecting the trademark indentation stiffness, all the indentations on the trademark are divided into two groups: the critical indentation group and the non-critical indentation group. The two groups of indentations are determined based on different quality standards. Different determination standards can be used to more accurately identify and eliminate unqualified trademarks, narrow the scope of elimination, and further avoid unnecessary waste.

3. According to the trademark surface condition, the bonding position of the trademark, and the material to which the trademark is bonded, the gluing region of the trademark is divided into a print surface gluing region and a non-print surface gluing region. Different detecting standards are formulated for different gluing regions, to more accurately control the moisture adsorption and desorption capacity of the trademark, which can improve the quality of the bonding position while avoiding unnecessary elimination, and reduce the defect rate while saving raw materials to a large extent. The print surface gluing region is pretreated before production, and different gluing methods are used for different regions during gluing to further improve the quality of the bonded position and reduce the defect rate.

4. When detecting the trademark surface friction coefficient, the movement of the trademark in the packaging machine is fully simulated. Static friction and dynamic friction are measured separately. To measure static friction and dynamic friction, the soft connection traction rope and the hard connection traction rope are used respectively to prevent the detection slider from bouncing during the detection process, to improve detection accuracy.

5. When detecting the trademark surface friction coefficient, according to the area of the contact surface between the trademark and the packaging machine during production and the pattern characteristics on each surface, sliders of different areas and different weights are paired and used for classified detection to further improve the detection accuracy.

### BRIEF DESCRIPTION OF THE DRAWINGS

FIG. 1 is a block diagram of a procedure of a method according to the present invention;

FIG. 2 is a schematic diagram of comparison between qualified trademark finished products and defective finished products caused by trademark gluing position defects according to the present invention;

FIG. 3 is a schematic diagram of comparison between qualified trademark finished products and defective finished products caused by trademark gluing position defects according to the present invention;

FIG. 4 is a schematic diagram of comparison between qualified trademark finished products and defective finished products caused by trademark indentation stiffness defects according to the present invention;

FIG. 5 is a schematic diagram of comparison between qualified trademark finished products and defective finished products caused by trademark indentation stiffness defects according to the present invention;

FIG. 6 is a schematic diagram of comparison between qualified trademark finished products and defective finished products caused by trademark friction coefficient defects according to the present invention;

FIG. 7 is a schematic diagram of comparison between qualified trademark finished products and defective finished products caused by trademark friction coefficient defects according to the present invention;

FIG. 8 is a schematic diagram of a print surface gluing region of a pack trademark according to Embodiment 1 of the present invention;

FIG. 9 is a schematic diagram of a non-print surface gluing region of a pack trademark according to Embodiment 1 of the present invention;

FIG. 10 is a schematic diagram of a non-print surface gluing region of a carton trademark according to Embodiment 1 of the present invention;

FIG. 11 is a schematic diagram of an 84 mm hardened standard pack trademark with a soft cover and a to-be-detected indentation sample according to Embodiment 2 of the present invention;

FIG. 12 is a schematic diagram of an 84 mm standard pack trademark with a hard cover and a to-be-detected indentation sample according to Embodiment 2 of the present invention;

FIG. 13 is a schematic diagram of an 84 mm thin pack trademark with a hard cover and a to-be-detected indentation sample according to Embodiment 2 of the present invention;

FIG. 14 is a schematic diagram of a 94 mm medium pack trademark with a hard cover and a to-be-detected indentation sample according to Embodiment 2 of the present invention;

FIG. 15 is a schematic diagram of a 100 mm thin pack trademark with a hard cover and a to-be-detected indentation sample according to Embodiment 2 of the present invention;

FIG. 16 is a schematic diagram of an 84 mm hardened standard carton trademark with a soft cover and a to-be-detected indentation sample according to Embodiment 2 of the present invention;

FIG. 17 is a schematic diagram of an 84 mm standard carton trademark with a hard cover and a to-be-detected indentation sample according to Embodiment 2 of the present invention;

FIG. 18 is a schematic diagram of an 84 mm thin carton trademark with a hard cover and a to-be-detected indentation sample according to Embodiment 2 of the present invention;

FIG. 19 is a schematic diagram of a 94 mm medium carton trademark with a hard cover and a to-be-detected indentation sample according to Embodiment 2 of the present invention;

FIG. 20 is a schematic diagram of a 100 mm thin carton trademark with a hard cover and a to-be-detected indentation sample according to Embodiment 2 of the present invention;

FIG. 21 is a schematic diagram of an 84 mm standard carton trademark with a soft cover and a to-be-detected indentation sample according to Embodiment 2 of the present invention;

FIG. 22 is a schematic diagram of a sample where a cut-out part of a to-be-detected indentation is located according to Embodiment 2 of the present invention;

FIG. 23 is a schematic structural diagram of a friction coefficient meter in a soft connection state according to Embodiment 3 of the present invention;

FIG. 24 is a schematic structural diagram of a friction coefficient meter in a hard connection state according to Embodiment 3 of the present invention;

FIG. 25 is a schematic diagram of a friction surface of a soft pack trademark according to Embodiment 3 of the present invention;

FIG. 26 is a schematic diagram of a soft pack trademark folded into a pack according to Embodiment 3 of the present invention;

FIG. 27 is a schematic diagram of a friction surface of a hard pack trademark according to Embodiment 3 of the present invention;

FIG. 28 is a schematic diagram of a hard pack trademark folded into a pack according to Embodiment 3 of the present invention;

FIG. 29 is a schematic diagram of the friction surface of a carton trademark according to Embodiment 3 of the present invention;

FIG. 30 is a schematic diagram of transporting a hard pack trademark folded into a pack in a packaging machine according to Embodiment 3 of the present invention; and

FIG. 31 is a schematic diagram of transporting a soft pack trademark folded into a pack in a packaging machine according to Embodiment 3 of the present invention.

In the accompanying drawings:
101-sensor, 105-hard connection traction rope, 102-horizontal detection bench, 103-slider,
104-measuring pad, 106-soft connection traction rope.

### DETAILED DESCRIPTION

In order to make it easy to understand the technical means, creative features and objectives achieved by the present invention, the technical solutions of the present invention will be further described below in conjunction with the embodiments and specific implementations of the qualification rate increasing method for finished products based on trademark parameter detection and control given in the present invention.

Specific embodiments given for the present invention are as follows:

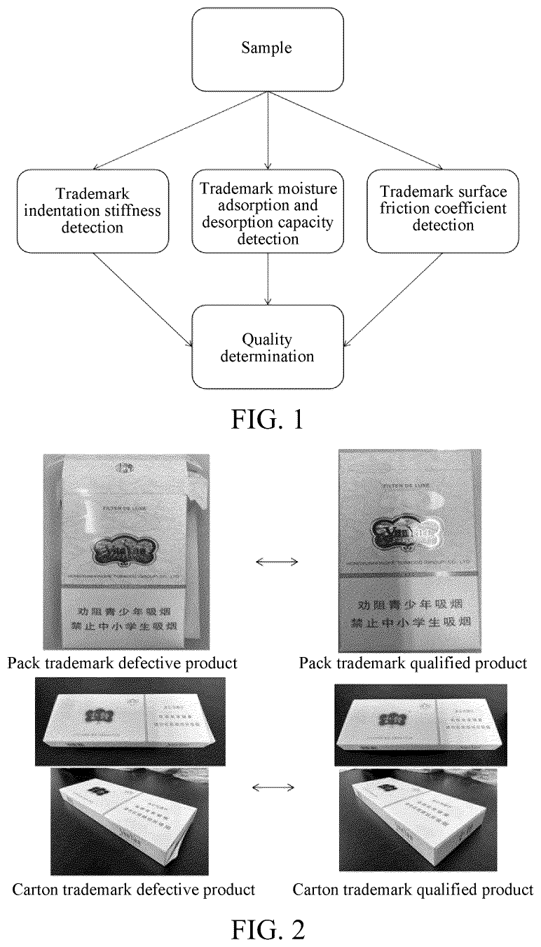

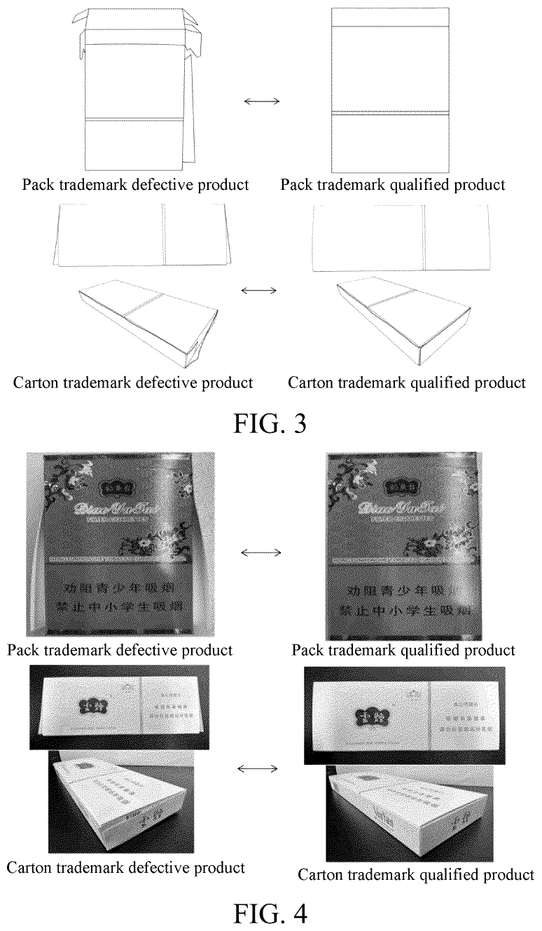

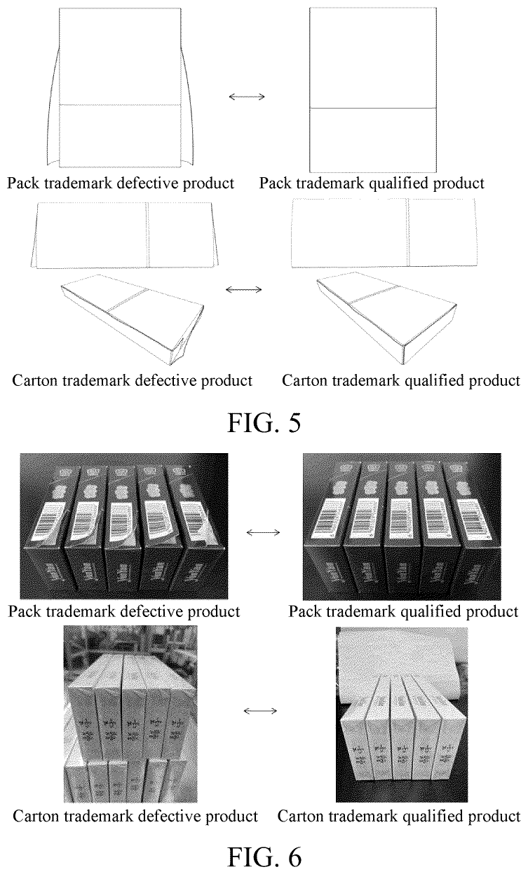

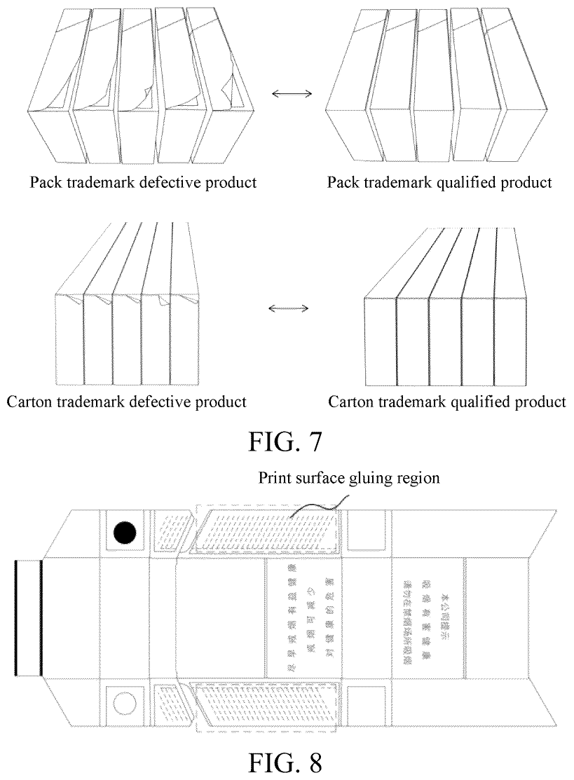

Embodiment 1: As shown in FIG. 1, the quality detection and control of the trademark gluing position includes the following steps:

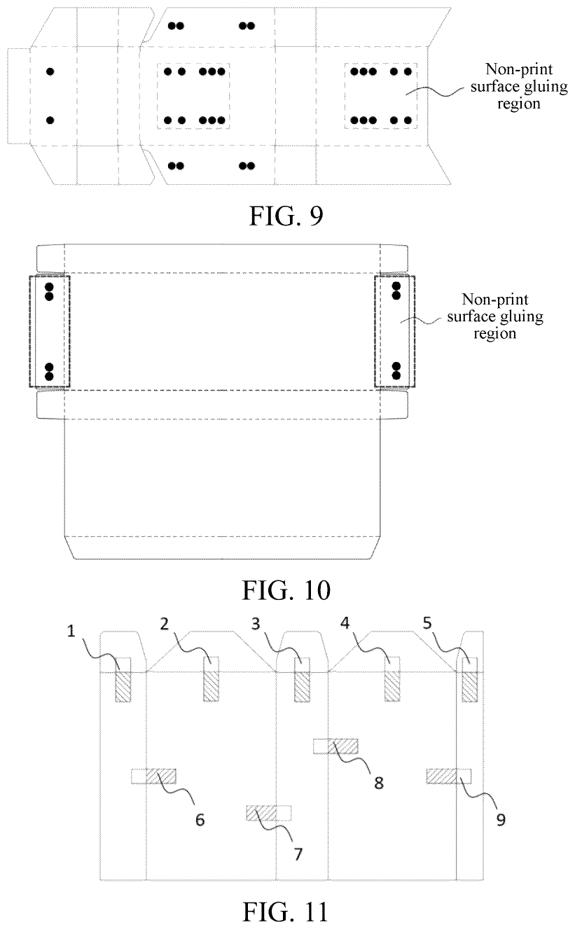

S1: Divide the gluing region: divide the trademark gluing region into a non-print surface gluing region and a print surface gluing region. The print surface gluing region of the pack trademark is shown in FIG. 8, the non-print surface gluing region of the pack trademark is shown in FIG. 9; the non-print surface gluing region of the carton trademark is shown in FIG. 10. The non-print surface gluing region includes a part on the non-print surface of the pack trademark that needs to be bonded to the lining paper and the inner frame paper, and a part on the non-print surface of the carton trademark that needs to be bonded with the print surface. The gluing method is to spray dots of glue through the glue nozzle for gluing; the print surface gluing region includes a part on the print surface of the pack trademark that is located on both sides of the pack trademark and is bonded to the non-print surface of the pack trademark when the package is folded. The gluing method is to apply strip gluing through a gluing roller.

S2: Pretreatment: pretreat the print surface gluing region to form a surface that is easy to absorb glue. The pretreatment includes indentation treatment or scraping treatment of the print surface gluing region, so that the original smooth print surface gluing region forms an uneven surface to facilitate glue absorption; the indentation treatment includes forming indentation lines or indentation points in the print surface gluing region, and the scraping treatment includes destroying the smooth surface of the print surface gluing region to form a hairy surface. Since a region close to the folding indentation position in the print surface gluing region is at the outer edge of the pack after folding into a pack, it is very easy for the glue to crack. When indentation treatment or scraping treatment is performed, the indentation line or indentation point or scraping density of the region is greater than that of other regions.

S3: Detect moisture adsorption and desorption capacity: sample from the to-be-detected batch of trademarks, and separately detect moisture adsorption and desorption capacity of the non-print surface gluing region and the print surface gluing region of the sample trademark. The moisture adsorption and desorption capacity detection includes the following steps:

S3.1: Sample: select a sample from the to-be-detected batch of trademarks, and place the selected sample trademark in an environment with a temperature of 22° C.±1° C. and a relative humidity of 60%±5% for equilibrium for twenty-four hours. Then, the non-print surface gluing region and the print surface gluing region on the selected sample trademark are cut and sampled respectively. When the sampled region includes both types of gluing regions, sampling is performed based on the print surface gluing region. Then, a to-be-detected part is cut into 40 mm*40 mm samples, and the samples are placed on a sample tray of a moisture adsorption and desorption detector, where a weight of the sample in each sample tray is controlled between 1.5 g and 3.5 g.

S3.2: Stage treatment: use a moisture adsorption and desorption detector to perform stage treatment on the sample in the sample tray; where the stage includes an equilibrium stage, a moisture absorption stage, and a dehumidification stage; parameter values for the equilibrium stage are set to temperature 24° C., humidity 60%, and treatment time of 5 minutes; parameter values for the moisture absorption stage are set to temperature 24° C., humidity 90%, and treatment time of 60 minutes; and parameter values of the dehumidification stage are set to temperature 24° C., humidity 60%, and treatment time of 60 minutes. The mass of the sample at the end of each stage is recorded.

S3.3: Perform calculation: according to the recorded mass of the sample at the end of each stage, calculate sample mass change rates in the moisture absorption stage and dehumidification stage respectively, that is, a ratio of a difference between the initial mass and the changed mass to the initial mass. These results represent the moisture absorption rate and the dehumidification rate of the sample respectively.

S4: Quality determination: compare the detection data with the internal control range, and when the moisture adsorption or desorption capacity of the sample trademark is unqualified in detection data of the non-print surface gluing region or the print surface gluing region of the selected sample trademark, it is determined that the moisture adsorption and desorption capacity of the sample trademark is unqualified; and when the defect rate of moisture adsorption and desorption capacity of detection samples of this batch of trademarks accounts for 10% or more, it is determined that this batch of trademarks is unqualified. The method for determining the internal control range is as follows: sampling a batch of trademarks that does not have any quality problems within a period of time, and measuring the moisture adsorption and desorption rate in each detection region of the sampled batch of trademarks and obtaining an average value, where the average value is a standard value of the moisture adsorption and desorption rate, removing a measurement value that deviates from the average value by more than twice the standard deviation, where the remaining minimum value and maximum value are the upper limit and lower limit of the internal control interval, and the interval between the final upper limit and lower limit is the internal control range. A negative sign (−) in the desorption rate simply indicates a decrease in the mass of the detected sample. The internal control range thereof is shown in the following table:

Internal control range value of moisture adsorption
and desorption of print surface gluing region
on pack trademark

| | Average | Minimum | Maximum |
|---|---|---|---|
| | internal | internal | internal |
| Print surface | control | control | control |
| gluing region | value | value | value |
| Adsorption rate (%) | 3.05 | 2.50 | 3.90 |
| Desorption rate (%) | −1.15 | −0.76 | −1.78 |

Internal control range value of moisture adsorption
and desorption of non-print surface gluing region
on pack trademark

| | Average | Minimum | Maximum |
|---|---|---|---|
| | internal | internal | internal |
| Non-print surface | control | control | control |
| gluing region | value | value | value |
| Adsorption rate (%) | 3.07 | 2.30 | 3.86 |
| Desorption rate (%) | −1.29 | −0.75 | −1.94 |

Internal control range value of moisture adsorption
and desorption of non-print surface gluing region
on carton trademark

| | Average | Minimum | Maximum |
|---|---|---|---|
| | internal | internal | internal |
| Print surface | control | control | control |
| gluing region | value | value | value |
| Adsorption rate (%) | 2.30 | 2.03 | 2.63 |
| Desorption rate (%) | −1.13 | −0.85 | −1.39 |

The above method is used to sample and detection a batch of pack trademarks and a batch of carton trademarks respectively. Results are shown in the following table:

Moisture adsorption and desorption detection result of print surface gluing region of
pack trademark sample

| | Sample | Sample | Sample | Sample | Sample | Sample | Sample | Sample | Sample | Sample |
|---|---|---|---|---|---|---|---|---|---|---|
| | 1 | 2 | 3 | 4 | 5 | 6 | 7 | 8 | 9 | 10 |
| Stage 1 (g) | 0.6768 | 0.6657 | 0.6632 | 0.6832 | 0.6714 | 0.6788 | 0.6767 | 0.6587 | 0.6691 | 0.6523 |
| Stage 2 (g) | 0.6978 | 0.6887 | 0.6863 | 0.7038 | 0.6914 | 0.6976 | 0.6967 | 0.6800 | 0.6935 | 0.6745 |
| Stage 3 (g) | 0.6900 | 0.6793 | 0.6796 | 0.6987 | 0.6869 | 0.6844 | 0.6859 | 0.6709 | 0.6877 | 0.6693 |
| Adsorption | 3.11 | 3.45 | 3.48 | 3.02 | 2.98 | 2.77 | 2.96 | 3.23 | 3.65 | 3.40 |
| rate | | | | | | | | | | |
| (%) | | | | | | | | | | |
| Desorption | −1.12 | −1.36 | −0.98 | −0.73 | −0.65 | −1.89 | −1.55 | −1.34 | −0.84 | −0.77 |
| rate | | | | | | | | | | |
| (%) | | | | | | | | | | |

Moisture adsorption and desorption detection result of non-print surface gluing region
of pack trademark sample

| | Sample | Sample | Sample | Sample | Sample | Sample | Sample | Sample | Sample | Sample |
|---|---|---|---|---|---|---|---|---|---|---|
| | 1 | 2 | 3 | 4 | 5 | 6 | 7 | 8 | 9 | 10 |
| Stage 1 (g) | 0.8103 | 0.8454 | 0.8085 | 0.8951 | 0.7992 | 0.8537 | 0.8617 | 0.8441 | 0.8396 | 0.8616 |
| Stage 2 (g) | 0.8303 | 0.8678 | 0.8256 | 0.9143 | 0.8212 | 0.8814 | 0.8886 | 0.8685 | 0.8609 | 0.8806 |
| Stage 3 (g) | 0.8233 | 0.8570 | 0.8164 | 0.9003 | 0.8131 | 0.8747 | 0.8768 | 0.8547 | 0.8548 | 0.8735 |
| Adsorption | 2.47 | 2.65 | 2.11 | 2.15 | 2.75 | 3.25 | 3.12 | 2.89 | 2.54 | 2.21 |
| rate | | | | | | | | | | |
| (%) | | | | | | | | | | |
| Desorption | −0.85 | −1.24 | −1.11 | −1.54 | −0.98 | −0.77 | −1.33 | −1.59 | −0.71 | −0.81 |
| rate | | | | | | | | | | |
| (%) | | | | | | | | | | |

From the detection results, it can be seen that the moisture desorption rates of the print surface gluing regions of samples 5 and 6 sampled from this batch of trademarks are unqualified, the moisture adsorption rates of the non-print surface gluing regions of samples 4 and 10 are unqualified, and the moisture adsorption rate of the non-print surface gluing region of sample 9 is unqualified. Therefore, samples 4, 5, 6, 9, and 10 are all unqualified samples. When the unqualified ratio of the detected samples accounts for 10% or more, it is determined that the batch of trademarks is unqualified. The proportion of unqualified samples among the detection samples selected from this batch of trademarks is 50%. Therefore, it is determined that this batch of trademarks is unqualified and this batch of trademarks is eliminated from the production raw materials. If there are too many trademarks in this batch, the number of samples should be appropriately increased for detection and determination again.

Moisture adsorption and desorption detection result of non-print surface gluing region
of carton trademark sample

| | Sample | Sample | Sample | Sample | Sample | Sample | Sample | Sample | Sample | Sample |
|---|---|---|---|---|---|---|---|---|---|---|
| | 1 | 2 | 3 | 4 | 5 | 6 | 7 | 8 | 9 | 10 |
| Stage 1 (g) | 1.4028 | 1.4006 | 1.3775 | 1.3722 | 1.4065 | 1.4105 | 1.4037 | 1.4060 | 1.4027 | 1.4053 |
| Stage 2 (g) | 1.4396 | 1.4343 | 1.4069 | 1.4025 | 1.4391 | 1.4424 | 1.4337 | 1.4380 | 1.4330 | 1.4411 |
| Stage 2 (g) | 1.4222 | 1.4203 | 1.3942 | 1.3899 | 1.4233 | 1.4274 | 1.4204 | 1.4240 | 1.4201 | 1.4221 |
| Adsorption | 2.56 | 2.35 | 2.09 | 2.16 | 2.27 | 2.21 | 2.09 | 2.23 | 2.16 | 2.55 |
| rate | | | | | | | | | | |
| (%) | | | | | | | | | | |
| Desorption | −1.22 | −0.99 | −0.91 | −0.91 | −1.11 | −1.05 | −0.94 | −0.98 | −0.90 | −1.32 |
| rate | | | | | | | | | | |
| (%) | | | | | | | | | | |

From the detection results, it can be seen that the moisture adsorption and desorption rates of the 10 samples selected from this batch of cigarette trademarks are all within the internal control range. Therefore, it is determined that this batch of carton trademarks is qualified and is qualified raw materials, and is expected to have good suitability to the machine and can enter the production process. If there are too many trademarks in this batch, the number of samples should be appropriately increased for detection and determination again.

Embodiment 2: the detection and control of the trademark indentation stiffness includes the following steps:

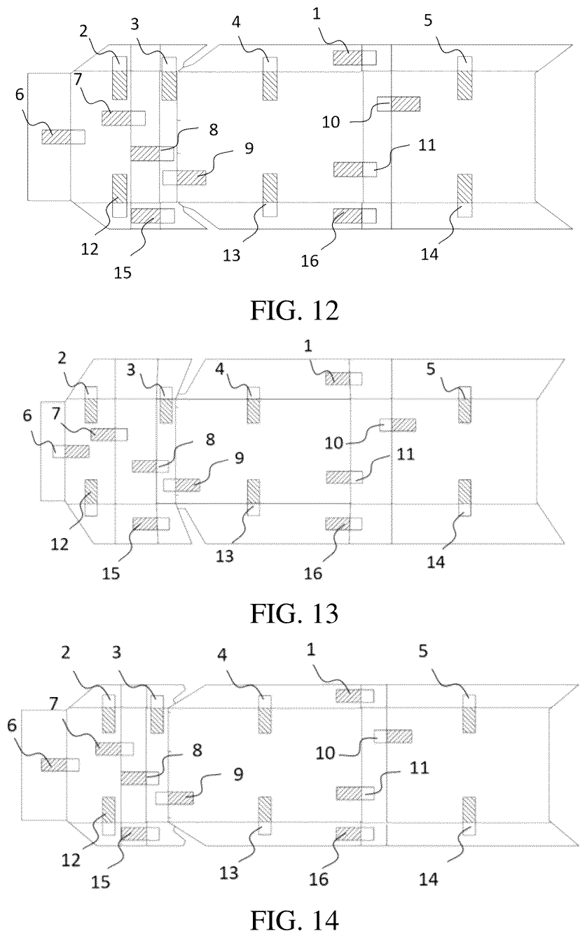

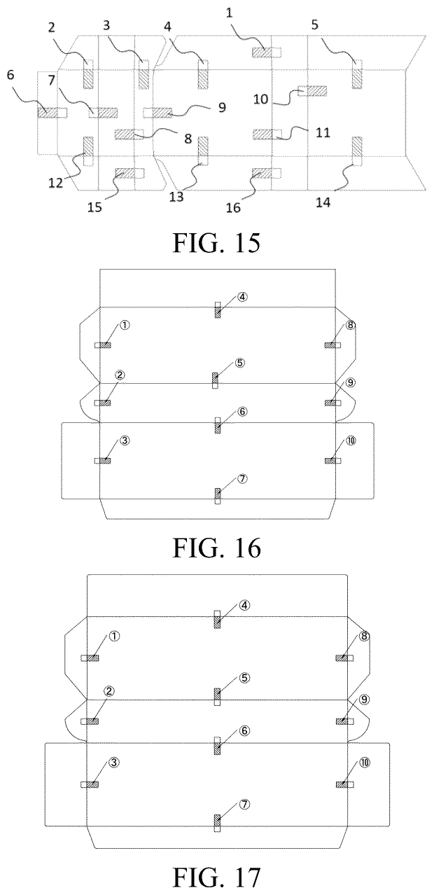

S1: Establish a to-be-detected indentation database; classify the trademarks according to trademark size data of each specification and the process of packaging trademarks into packs in the packaging machine; where the trademark classification includes pack trademarks and carton trademarks, and the carton trademarks include an 84 mm hardened standard pack trademark with a soft cover, an 84 mm standard pack trademark with a hard cover, an 84 mm thin pack trademark with a hard cover, a 94 mm medium pack trademark with a hard cover, and a 100 mm thin pack trademark with a hard cover. As shown in FIG. 11, there are a total of nine cartons of 84 mm hardened standard pack trademarks with a soft cover. As shown in FIG. 12 to FIG. 15, the 84 mm standard pack trademarks with a hard cover, the 84 mm thin pack trademarks with a hard cover, the 94 mm medium pack trademarks with a hard cover, and the 100 mm thin pack trademarks with a hard cover each have sixteen to-be-detected indentations. Because the print patterns and print methods of brands are different, trademarks of various specifications are separately detected and standards are determined according to brands. A batch of trademarks of each category that does not have any quality problems within a period of time is sampled, and each to-be-detected indentation stiffness of the sampled batch of trademarks is measured and an average value is obtained, where the average value is a standard value of the indentation stiffness, a measurement value that deviates from the average value by more than twice the standard deviation is removed, the remaining minimum value and maximum value are the upper limit and lower limit of the internal control interval, and the interval between the final upper limit and lower limit is the internal control range, and a to-be-detected indentation stiffness database is established. The internal control range values of the indentation stiffness of pack trademarks of various specifications and brands are shown in the following table:

Internal control range value of indentation stiffness of 84 mm hardened standard pack
trademark with soft cover (unit: gf)

| | Brand A | | | Brand B | | | Brand C | | |
|---|---|---|---|---|---|---|---|---|---|
| | Average | Minimum | Maximum | Average | Minimum | Maximum | Average | Minimum | Maximum |
| Indentation | internal | internal | internal | internal | internal | internal | internal | internal | internal |
| serial | control | control | control | control | control | control | control | control | control |
| number | value | value | value | value | value | value | value | value | value |
| 1 | 8.65 | 8.00 | 9.76 | 6.74 | 5.71 | 7.63 | 7.52 | 6.92 | 8.03 |
| 2 | 8.61 | 7.77 | 9.27 | 6.53 | 5.40 | 7.53 | 7.49 | 6.12 | 9.43 |
| 3 | 8.89 | 8.28 | 9.84 | 6.69 | 5.10 | 7.60 | 7.51 | 6.59 | 9.52 |
| 4 | 8.17 | 7.27 | 8.53 | 6.18 | 5.41 | 7.44 | 6.89 | 6.18 | 8.17 |
| 5 | 8.84 | 7.86 | 10.13 | 6.56 | 5.70 | 7.84 | 7.31 | 5.68 | 8.97 |
| 6 | 10.77 | 8.79 | 13.36 | 7.65 | 6.06 | 9.31 | 8.82 | 7.24 | 9.58 |
| 7 | 12.36 | 9.75 | 14.64 | 7.79 | 6.79 | 10.13 | 8.66 | 7.76 | 9.40 |
| 8 | 11.56 | 9.94 | 14.09 | 7.59 | 6.78 | 8.35 | 9.15 | 8.26 | 10.87 |
| 9 | 11.27 | 9.16 | 13.15 | 7.85 | 6.97 | 9.13 | 9.31 | 7.06 | 10.91 |

Internal control range value of indentation stiffness of 84 mm standard pack trademark
with hard cover (unit: gf)

| | Brand D | | | Brand E | | | Brand F | | |
|---|---|---|---|---|---|---|---|---|---|
| | Average | Minimum | Maximum | Average | Minimum | Maximum | Average | Minimum | Maximum |
| Indentation | internal | internal | internal | internal | internal | internal | internal | internal | internal |
| serial | control | control | control | control | control | control | control | control | control |
| number | value | value | value | value | value | value | value | value | value |
| 1 | 16.00 | 13.33 | 17.83 | 18.87 | 14.48 | 22.77 | 19.82 | 18.18 | 22.43 |
| 2 | 17.61 | 14.87 | 21.80 | 16.62 | 14.34 | 18.29 | 20.74 | 19.05 | 22.07 |
| 3 | 16.55 | 14.47 | 20.19 | 15.40 | 14.43 | 16.23 | 20.71 | 16.79 | 23.87 |
| 4 | 15.04 | 13.51 | 18.11 | 15.81 | 15.41 | 16.28 | 18.62 | 18.30 | 19.41 |
| 5 | 13.89 | 12.51 | 15.41 | 15.01 | 13.89 | 16.53 | 21.10 | 19.58 | 23.35 |
| 6 | 13.63 | 11.67 | 15.23 | 15.41 | 13.31 | 17.94 | 18.30 | 17.89 | 18.80 |
| 7 | 13.72 | 11.59 | 16.73 | 17.40 | 13.83 | 20.17 | 17.69 | 15.08 | 20.24 |
| 8 | 14.84 | 12.36 | 17.40 | 17.79 | 13.71 | 22.11 | 16.99 | 15.02 | 19.22 |
| 9 | 13.96 | 12.50 | 14.83 | 15.34 | 13.29 | 18.14 | 15.90 | 14.19 | 18.19 |
| 10 | 15.26 | 12.49 | 16.92 | 15.89 | 13.77 | 21.07 | 15.75 | 13.71 | 18.91 |
| 11 | 14.29 | 12.18 | 16.65 | 16.97 | 13.61 | 20.73 | 16.60 | 15.78 | 18.31 |
| 12 | 19.62 | 16.30 | 22.16 | 20.18 | 18.26 | 22.35 | 22.34 | 19.91 | 24.04 |
| 13 | 18.01 | 15.23 | 23.88 | 19.74 | 17.37 | 22.56 | 19.02 | 18.22 | 20.01 |
| 14 | 19.24 | 17.04 | 22.89 | 19.43 | 17.89 | 21.90 | 20.85 | 18.49 | 25.36 |
| 15 | 14.59 | 13.16 | 16.67 | 17.46 | 14.80 | 22.49 | 17.35 | 15.24 | 19.54 |
| 16 | 15.11 | 12.31 | 17.49 | 18.42 | 16.21 | 21.30 | 19.08 | 17.06 | 22.63 |

Internal control range value of indentation stiffness of 84 mm thin
pack trademark with hard cover (unit: gf)

| | Brand G | | | Brand H | | |
|---|---|---|---|---|---|---|
| | Aver- | Mini- | Maxi- | Aver- | Mini- | Maxi- |
| Inden- | age | mum | mum | age | mum | mum |
| tation | internal | internal | internal | internal | internal | internal |
| serial | control | control | control | control | control | control |
| number | value | value | value | value | value | value |
| 1 | 15.64 | 12.48 | 17.50 | 14.46 | 11.77 | 18.49 |
| 2 | 17.39 | 15.30 | 19.99 | 14.18 | 13.53 | 15.02 |
| 3 | 17.93 | 15.76 | 20.69 | 15.30 | 11.55 | 18.64 |
| 4 | 19.94 | 14.75 | 22.98 | 13.34 | 11.44 | 14.81 |
| 5 | 18.08 | 13.75 | 23.49 | 14.18 | 12.03 | 17.32 |
| 6 | 15.01 | 11.86 | 17.02 | 10.61 | 8.11 | 13.84 |
| 7 | 13.98 | 11.28 | 16.47 | 9.76 | 8.03 | 11.04 |
| 8 | 16.57 | 13.16 | 18.60 | 11.86 | 9.01 | 15.46 |
| 9 | 16.10 | 12.38 | 18.24 | 14.64 | 13.90 | 15.56 |
| 10 | 13.32 | 11.17 | 15.06 | 12.86 | 12.07 | 13.83 |
| 11 | 13.96 | 12.00 | 16.91 | 12.01 | 11.30 | 13.33 |
| 12 | 18.02 | 15.65 | 19.69 | 14.62 | 12.16 | 18.43 |
| 13 | 18.55 | 15.29 | 20.99 | 14.91 | 11.91 | 17.85 |
| 14 | 16.69 | 12.77 | 19.37 | 15.08 | 13.24 | 17.36 |
| 15 | 15.19 | 13.23 | 16.85 | 13.68 | 10.24 | 16.90 |
| 16 | 16.16 | 14.45 | 17.80 | 14.05 | 11.02 | 17.71 |

Internal control range value of indentation stiffness of 94 mm
medium pack trademark with hard cover (unit: gf)

| | Brand I | | | Brand J | | |
|---|---|---|---|---|---|---|
| | | Mini- | | | Mini- | |
| Inden- | Average | mum | Maximum | Average | mum | Maximum |
| tation | internal | internal | internal | internal | internal | internal |
| serial | control | control | control | control | control | control |
| number | value | value | value | value | value | value |
| 1 | 17.02 | 12.42 | 20.16 | 18.26 | 17.04 | 19.09 |
| 2 | 17.43 | 12.70 | 20.30 | 13.21 | 11.90 | 14.24 |
| 3 | 19.97 | 14.16 | 23.81 | 13.06 | 11.66 | 15.09 |
| 4 | 16.49 | 14.34 | 18.64 | 13.56 | 12.42 | 14.10 |
| 5 | 16.49 | 13.35 | 19.24 | 14.50 | 13.39 | 15.61 |
| 6 | 15.08 | 12.09 | 16.68 | 16.94 | 14.84 | 19.75 |
| 7 | 13.34 | 10.29 | 15.93 | 21.64 | 18.87 | 23.99 |
| 8 | 13.41 | 11.38 | 15.07 | 20.94 | 18.97 | 22.60 |
| 9 | 13.89 | 10.64 | 15.66 | 17.56 | 14.56 | 20.28 |
| 10 | 14.43 | 10.92 | 18.23 | 22.07 | 21.29 | 23.03 |
| 11 | 12.18 | 10.97 | 14.05 | 16.48 | 14.56 | 18.12 |
| 12 | 15.64 | 12.50 | 19.28 | 15.39 | 13.45 | 17.12 |
| 13 | 15.55 | 13.61 | 17.13 | 17.38 | 15.74 | 18.55 |
| 14 | 15.27 | 12.54 | 17.59 | 17.98 | 15.57 | 19.90 |
| 15 | 13.87 | 11.78 | 16.79 | 19.77 | 17.86 | 22.87 |
| 16 | 15.25 | 12.50 | 18.20 | 21.63 | 18.67 | 24.58 |

Internal control range value of indentation stiffness of 100 mm thin pack trademark
with hard cover (unit: gf)

| | Brand K | | | Brand L | | | Brand M | | |
|---|---|---|---|---|---|---|---|---|---|
| | | Mini- | | | Mini- | | | Mini- | |
| Inden- | Average | mum | Maximum | Average | mum | Maximum | Average | mum | Maximum |
| tation | internal | internal | internal | internal | internal | internal | internal | internal | internal |
| serial | control | control | control | control | control | control | control | control | control |
| number | value | value | value | value | value | value | value | value | value |
| 1 | 14.05 | 10.87 | 20.10 | 17.04 | 16.90 | 17.17 | 19.03 | 17.65 | 20.06 |
| 2 | 14.05 | 11.80 | 16.93 | 21.53 | 20.69 | 22.36 | 19.05 | 16.88 | 21.56 |
| 3 | 16.01 | 13.28 | 19.63 | 21.61 | 20.75 | 22.47 | 19.71 | 16.60 | 21.19 |
| 4 | 13.03 | 10.71 | 16.36 | 17.71 | 16.33 | 19.08 | 18.44 | 16.08 | 20.18 |
| 5 | 13.95 | 11.17 | 17.05 | 20.42 | 20.27 | 20.57 | 19.05 | 16.81 | 21.73 |
| 6 | 12.41 | 10.77 | 14.41 | 15.94 | 15.92 | 15.96 | 15.42 | 13.76 | 17.89 |
| 7 | 12.40 | 10.97 | 14.62 | 16.45 | 16.23 | 16.66 | 15.72 | 14.99 | 17.73 |
| 8 | 12.58 | 10.29 | 15.50 | 16.67 | 15.73 | 17.60 | 16.43 | 14.80 | 17.53 |
| 9 | 11.91 | 10.08 | 15.41 | 17.91 | 17.57 | 18.24 | 16.01 | 14.84 | 16.81 |
| 10 | 11.82 | 10.13 | 17.39 | 15.35 | 15.07 | 15.62 | 16.23 | 15.44 | 17.32 |
| 11 | 12.32 | 10.30 | 15.62 | 17.03 | 16.65 | 17.41 | 15.70 | 14.22 | 18.23 |
| 12 | 14.88 | 13.09 | 17.12 | 22.44 | 22.17 | 22.70 | 18.47 | 17.97 | 19.38 |
| 13 | 14.54 | 12.93 | 16.82 | 19.14 | 18.22 | 20.05 | 17.13 | 15.98 | 18.74 |
| 14 | 14.34 | 12.44 | 16.91 | 20.47 | 20.10 | 20.83 | 17.27 | 16.00 | 19.31 |
| 15 | 14.25 | 11.82 | 16.57 | 16.23 | 15.59 | 16.86 | 16.37 | 15.41 | 17.97 |
| 16 | 14.18 | 12.05 | 17.28 | 18.36 | 17.67 | 19.05 | 16.28 | 13.93 | 17.82 |

S2: Sample: before production, sample raw material trademarks according to batches, and cut and sample to-be-measured indentations of the selected samples according to a specification of the batch of trademarks; as shown in FIG. 11 to FIG. 15, when sampling, select a region where the midpoint of the indentation is located; and if the two indentations are too close to each other or sampling regions where the midpoints of the indentations are located at the same time causes overlap and conflict in sampling parts, respectively select regions where points in one-third positions at opposite ends of the two close indentations are located. As shown in FIG. 22, when sampling, a sample shape of the part cut from the indentation is a rectangle, the rectangle is divided into a bending length part and a clamping depth part with the part cut from the indentation as the boundary; the bending length part is a square with the part cut from the indentation as one side, the clamping depth part is a rectangle with the part cut from the indentation as a short side, and a length ratio of the long side to the short side is two to one. The length of the part cut when sampling the to-be-measured indentation is 6 mm.

S3: Stiffness detection: place the to-be-measured indentation sample after sampling in step S2 in an environment with a temperature of 22° C.±1° C. and a relative humidity of 60%±5% for equilibrium for twenty-four hours, and use a bending stiffness meter to detect stiffness of a selected indentation sample, record a detection result, compare measured stiffness data with the internal control range, and determine whether the stiffness of the sample trademark indentation is qualified based on a comparison result.

S4: Quality determination: divide all indentations into a critical indentation group and a non-critical indentation group, where indentations at gluing and folding positions and indentations at critical folding positions for cigarette pack forming belong to the critical indentation group, and the remaining indentations belong to the non-critical indentation group, if the critical indentation group includes an indentation with stiffness exceeding an internal control range, determine that the trademark indentation stiffness quality fails, and if the non-critical indentation group includes more than two indentations with stiffness exceeding the internal control range, determine that the trademark indentation stiffness quality fails, compare based on the indentation stiffness measurement result of the sample trademark to determine whether the batch of trademarks of the sample meets the production requirement, and if the defect rate of single indentation stiffness in this batch of samples accounts for 10% or more, determine that this batch of trademarks is unqualified.

The above method is used to sample and detect a batch of 100 mm thin pack trademarks with a hard cover of a brand K. Detection results are as shown in the table below:

Sampling inspection data of 100 mm thin pack trademark with a hard cover of a brand
K (unit: gf)

| Indentation | | | | | | | | |
|---|---|---|---|---|---|---|---|---|
| serial | | | | | | | | |
| number | Sample 1 | Sample 2 | Sample 3 | Sample 4 | Sample 5 | Sample 6 | Sample 7 | Sample 8 |
| 1 | 15.73 | 14.01 | 15.79 | 15.89 | 13.15 | 13.31 | 14.44 | 14.85 |
| 2 | 13.35 | 15.32 | 13.33 | 14.19 | 13.94 | 14.63 | 14.61 | 14.85 |
| 3 | 14.73 | 13.13 | 13.56 | 14.68 | 14.98 | 14.05 | 15.76 | 15.22 |
| 4 | 14.27 | 15.06 | 15.51 | 14.77 | 13.54 | 15.64 | 13.44 | 14.82 |
| 5 | 15.16 | 15.00 | 14.96 | 13.74 | 13.39 | 15.11 | 14.32 | 15.44 |
| 6 | 14.98 | 13.06 | 13.61 | 14.44 | 14.24 | 14.19 | 15.11 | 15.26 |
| 7 | 15.73 | 15.04 | 14.39 | 14.11 | 15.06 | 14.57 | 15.41 | 15.81 |
| 8 | 14.87 | 15.00 | 13.01 | 14.41 | 15.41 | 14.34 | 14.61 | 13.02 |
| 9 | 13.35 | 13.80 | 14.08 | 13.55 | 15.07 | 14.72 | 15.02 | 14.58 |
| 10 | 14.90 | 15.32 | 14.53 | 14.50 | 13.40 | 14.10 | 13.22 | 13.72 |
| 11 | 14.31 | 15.08 | 15.14 | 14.71 | 15.91 | 14.16 | 13.80 | 14.92 |
| 12 | 15.21 | 13.19 | 13.72 | 15.20 | 14.99 | 15.30 | 15.25 | 13.57 |
| 13 | 15.39 | 13.48 | 14.98 | 13.17 | 15.12 | 14.62 | 13.63 | 15.00 |
| 14 | 13.71 | 15.47 | 15.41 | 13.57 | 13.22 | 13.33 | 15.43 | 13.15 |
| 15 | 14.56 | 15.25 | 14.12 | 13.96 | 14.84 | 13.45 | 13.24 | 13.02 |
| 16 | 13.45 | 15.79 | 15.02 | 15.35 | 14.22 | 14.65 | 14.88 | 13.48 |

Indentations 2, 12, 3, 4, 13, 5, and 14 are at the gluing position, and if they are not folded well, the glue is not strong. Indentations 7, 8, 9, 10, and 11 are at the critical positions for cigarette pack forming, and if they are not folded well, defects such as the exposed lid and inconsistent upper and lower widths appear after the cigarette pack is formed. Therefore, the indentations 2, 12, 3, 4, 13, 5, 14, 7, 8, 9, 10, and 11 belong to the critical indentation group. Indentations 1, 6, 15, and 16 are not in critical positions for gluing and packaging, and have little impact on the gluing and forming effects, and belong to the non-critical indentation group.

Through data comparison, it can be determined that among the 8 samples measured, only the indentation stiffness of sample 3, sample 4 and sample 6 is within the internal control range, and these samples are pack trademarks with qualified indentation stiffness. Stiffness of indentation 8 of sample 1, sample 7, and sample 8 exceeds the internal control range, and indentation 8 is a critical indentation. Therefore, sample 1, sample 7, and sample 8 are pack trademarks with unqualified indentation stiffness. The stiffness of indentation 4 and indentation 8 of sample 2 exceeds the internal control range, and indentation 3 and indentation 8 are critical indentations. Therefore, sample 2 is a pack trademark with unqualified indentation stiffness. The stiffness of indentation 8 and indentation 13 of sample 5 exceeds the internal control range, and indentation 8 and indentation 13 are critical indentations. Therefore, sample 5 is a pack trademark with unqualified indentation stiffness.

To sum up, 3 of the 8 samples sampled from this batch of 100 mm thin pack trademarks with a hard cover of a brand K are qualified, with a qualification rate of 37.5%. When the unqualified indentation stiffness ratio of the detected samples accounts for 10% or more, it is determined that the batch of pack trademarks is unqualified. Therefore, raw materials of this batch of pack trademarks cause the production of defective cigarette packs, and raw materials of this batch of trademarks can be eliminated before production. If there are too many trademarks in this batch, the number of samples should be appropriately increased for detection and determination again.

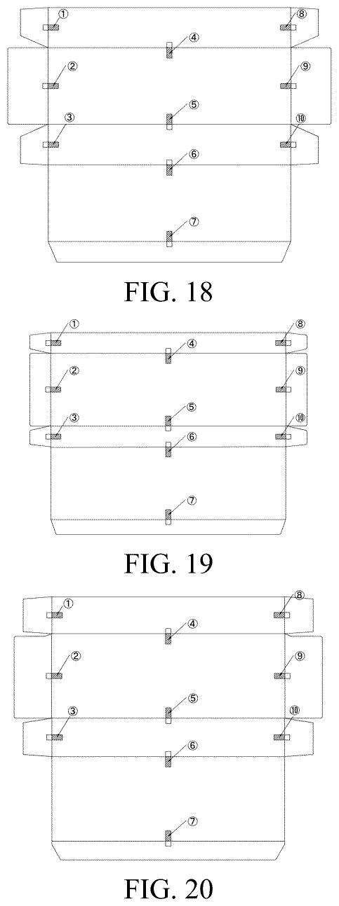

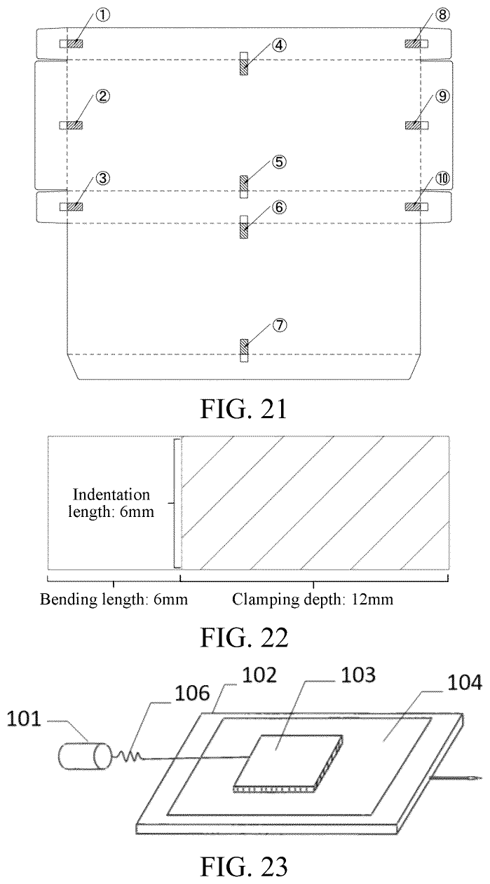

The above method is used to detect the stiffness of the carton trademarks. The carton trademarks include an 84 mm hardened standard carton trademark with a soft cover, an 84 mm standard carton trademark with a hard cover, an 84 mm thin carton trademark with a hard cover, a 94 mm medium carton trademark with a hard cover, a 100 mm thin carton trademark with a hard cover, and an 84 mm standard carton trademark with a soft cover. FIG. 16 to FIG. 21 are sequentially schematic diagrams of an 84 mm hardened standard carton trademark with a soft cover, an 84 mm standard carton trademark with a hard cover, an 84 mm thin carton trademark with a hard cover, a 94 mm medium carton trademark with a hard cover, a 100 mm thin carton trademark with a hard cover, and an 84 mm standard carton trademark with a soft cover, to-be-measured indentations, and indentation samples. The number of to-be-measured indentations on the carton trademark is ten. The internal control range values of the indentation stiffness of carton trademarks of various specifications and brands determined in accordance with the determination method for internal control range values are shown in the following table:

Internal control range value of indentation stiffness of 84 mm hardened standard carton
trademark with soft cover (unit: gf)

| | Brand A | | | Brand B | | | Brand C | | |
|---|---|---|---|---|---|---|---|---|---|
| | | Mini- | | | Mini- | | | Mini- | |
| Inden- | Average | mum | Maximum | Average | mum | Maximum | Average | mum | Maximum |
| tation | internal | internal | internal | internal | internal | internal | internal | internal | internal |
| serial | control | control | control | control | control | control | control | control | control |
| number | value | value | value | value | value | value | value | value | value |
| 1 | 13.07 | 12.51 | 15.42 | 12.96 | 11.49 | 14.43 | 11.67 | 10.38 | 12.95 |
| 2 | 13.44 | 11.23 | 15.65 | 13.78 | 12.04 | 15.54 | 13.10 | 12.08 | 14.12 |
| 3 | 12.64 | 9.29 | 15.98 | 12.13 | 9.67 | 14.58 | 12.35 | 11.04 | 13.66 |
| 4 | 12.87 | 10.34 | 15.40 | 13.28 | 11.08 | 15.47 | 13.82 | 11.74 | 15.90 |
| 5 | 12.39 | 9.48 | 15.29 | 13.73 | 12.01 | 15.45 | 13.61 | 12.54 | 14.69 |
| 6 | 12.38 | 10.48 | 14.28 | 14.12 | 12.25 | 15.99 | 11.76 | 9.34 | 14.18 |
| 7 | 13.16 | 12.45 | 13.87 | 11.95 | 9.79 | 14.11 | 12.12 | 10.81 | 13.43 |
| 8 | 11.06 | 9.69 | 12.43 | 13.45 | 12.42 | 14.48 | 11.68 | 9.11 | 14.24 |
| 9 | 12.82 | 11.38 | 14.26 | 12.49 | 10.62 | 14.36 | 12.03 | 11.42 | 12.56 |
| 10 | 10.80 | 9.03 | 12.57 | 11.88 | 9.29 | 14.46 | 12.33 | 11.16 | 13.49 |

Internal control range value of indentation stiffness of 84 mm standard carton
trademark with hard cover (unit: gf)

| | Brand D | | | Brand E | | | Brand F | | |
|---|---|---|---|---|---|---|---|---|---|
| | | Mini- | | | Mini- | | | Mini- | |
| Inden- | Average | mum | Maximum | Average | mum | Maximum | Average | mum | Maximum |
| tation | internal | internal | internal | internal | internal | internal | internal | internal | internal |
| serial | control | control | control | control | control | control | control | control | control |
| number | value | value | value | value | value | value | value | value | value |
| 1 | 13.47 | 12.35 | 14.59 | 14.05 | 12.91 | 15.18 | 11.23 | 10.07 | 12.38 |
| 2 | 11.42 | 10.22 | 13.15 | 11.70 | 9.59 | 13.81 | 11.20 | 9.27 | 13.13 |
| 3 | 12.01 | 11.09 | 12.93 | 12.21 | 10.34 | 14.07 | 11.92 | 10.58 | 13.25 |
| 4 | 12.59 | 10.11 | 15.08 | 11.53 | 9.03 | 14.03 | 13.25 | 10.99 | 15.51 |
| 5 | 11.07 | 10.05 | 13.88 | 12.78 | 11.82 | 13.74 | 12.05 | 10.82 | 13.28 |
| 6 | 12.84 | 11.04 | 14.64 | 12.73 | 10.74 | 14.73 | 11.34 | 10.63 | 13.06 |
| 7 | 11.95 | 10.57 | 13.33 | 13.27 | 11.34 | 15.21 | 12.52 | 9.04 | 16.00 |
| 8 | 13.25 | 10.72 | 15.79 | 10.96 | 9.39 | 12.54 | 12.00 | 10.29 | 13.71 |
| 9 | 11.58 | 10.38 | 12.24 | 13.94 | 12.52 | 15.36 | 10.81 | 9.20 | 12.43 |
| 10 | 13.06 | 11.92 | 14.21 | 11.46 | 9.88 | 12.67 | 13.28 | 12.12 | 14.44 |

Internal control range value of indentation stiffness of 84 mm standard carton
trademark with soft cover (unit: gf)

| Brand N | | | | | | | | | | |
|---|---|---|---|---|---|---|---|---|---|---|
| Indentation | | | | | | | | | | |
| serial number | 1 | 2 | 3 | 4 | 5 | 6 | 7 | 8 | 9 | 10 |
| Average | 13.79 | 11.29 | 13.16 | 13.63 | 12.37 | 12.43 | 13.81 | 12.58 | 14.03 | 11.8 |
| internal | | | | | | | | | | |
| control value | | | | | | | | | | |
| Minimum | 12.5 | 10.5 | 10.94 | 12.9 | 10.3 | 9.81 | 12.4 | 10.53 | 12.86 | 11.26 |
| internal | | | | | | | | | | |
| control value | | | | | | | | | | |
| Maximum | 15.08 | 12.08 | 15.39 | 14.36 | 14.44 | 15.05 | 15.22 | 14.64 | 15.21 | 12.35 |
| internal | | | | | | | | | | |
| control value | | | | | | | | | | |

Internal control range value of indentation stiffness of 84 mm thin carton trademark
with hard cover (unit: gf)

| | Brand G | | | Brand H | | | Brand O | | |
|---|---|---|---|---|---|---|---|---|---|
| | | Mini- | | | Mini- | | | Mini- | |
| Inden- | Average | mum | Maximum | Average | mum | Maximum | Average | mum | Maximum |
| tation | internal | internal | internal | internal | internal | internal | internal | internal | internal |
| serial | control | control | control | control | control | control | control | control | control |
| number | value | value | value | value | value | value | value | value | value |
| 1 | 13.26 | 10.59 | 15.94 | 11.10 | 9.44 | 12.77 | 11.86 | 9.84 | 13.87 |
| 2 | 14.12 | 12.45 | 15.78 | 13.49 | 12.21 | 14.76 | 12.89 | 9.79 | 15.98 |
| 3 | 11.67 | 10.36 | 12.99 | 11.37 | 10.22 | 13.44 | 13.66 | 12.75 | 14.57 |
| 4 | 12.84 | 9.81 | 15.87 | 13.88 | 12.06 | 15.70 | 13.00 | 10.18 | 15.86 |
| 5 | 11.87 | 11.50 | 12.24 | 10.96 | 9.00 | 12.93 | 11.17 | 9.64 | 12.24 |
| 6 | 12.45 | 12.20 | 12.70 | 11.96 | 9.27 | 14.65 | 11.70 | 9.26 | 12.80 |
| 7 | 12.00 | 10.22 | 13.79 | 12.47 | 9.56 | 15.37 | 12.72 | 10.30 | 15.14 |
| 8 | 10.68 | 9.07 | 12.29 | 12.32 | 10.41 | 13.19 | 11.81 | 9.16 | 14.47 |
| 9 | 11.88 | 11.02 | 12.74 | 12.76 | 9.92 | 15.61 | 12.63 | 9.79 | 15.54 |
| 10 | 12.43 | 10.44 | 14.43 | 12.61 | 10.96 | 13.26 | 11.86 | 9.44 | 14.28 |

Internal control range value of indentation stiffness of 94 mm
medium carton trademark with hard cover (unit: gf)

| | Brand I | | | Brand J | | |
|---|---|---|---|---|---|---|
| | | Mini- | | | Mini- | |
| Inden- | Average | mum | Maximum | Average | mum | Maximum |
| tation | internal | internal | internal | internal | internal | internal |
| serial | control | control | control | control | control | control |
| number | value | value | value | value | value | value |
| 1 | 13.30 | 11.28 | 15.35 | 13.04 | 12.38 | 14.70 |
| 2 | 10.88 | 9.14 | 12.07 | 13.27 | 11.97 | 14.57 |
| 3 | 11.39 | 9.70 | 13.08 | 12.12 | 10.95 | 13.26 |
| 4 | 11.66 | 9.36 | 13.97 | 10.54 | 9.32 | 12.66 |
| 5 | 13.25 | 12.19 | 14.32 | 12.46 | 9.94 | 14.98 |
| 6 | 12.39 | 10.26 | 14.53 | 13.17 | 10.81 | 15.54 |
| 7 | 10.23 | 9.64 | 12.11 | 11.87 | 9.47 | 14.27 |
| 8 | 12.03 | 10.45 | 13.60 | 11.31 | 9.43 | 13.19 |
| 9 | 12.49 | 11.44 | 16.54 | 11.03 | 9.93 | 12.12 |
| 10 | 10.60 | 10.08 | 12.12 | 14.38 | 12.72 | 15.94 |

Internal control range value of indentation stiffness of 100 mm thin carton trademark
with hard cover (unit: gf)

| | Brand K | | | Brand L | | | Brand M | | |
|---|---|---|---|---|---|---|---|---|---|
| | | Mini- | | | Mini- | | | Mini- | |
| Inden- | Average | mum | Maximum | Average | mum | Maximum | Average | mum | Maximum |
| tation | internal | internal | internal | internal | internal | internal | internal | internal | internal |
| serial | control | control | control | control | control | control | control | control | control |
| number | value | value | value | value | value | value | value | value | value |
| 1 | 14.35 | 11.80 | 16.91 | 12.12 | 10.57 | 13.67 | 14.17 | 12.10 | 16.24 |
| 2 | 12.12 | 10.12 | 14.11 | 12.69 | 10.31 | 15.36 | 14.28 | 12.79 | 15.78 |
| 3 | 11.35 | 9.78 | 12.92 | 11.50 | 10.07 | 12.93 | 11.62 | 9.70 | 13.54 |
| 4 | 11.13 | 9.72 | 12.54 | 11.52 | 10.87 | 13.54 | 12.00 | 10.49 | 13.51 |
| 5 | 11.59 | 9.01 | 14.16 | 12.63 | 10.02 | 15.23 | 12.74 | 12.30 | 13.17 |
| 6 | 12.76 | 9.91 | 15.60 | 10.90 | 9.51 | 12.15 | 12.66 | 10.57 | 14.76 |
| 7 | 14.05 | 12.53 | 15.57 | 12.45 | 11.63 | 15.23 | 11.61 | 9.26 | 13.96 |
| 8 | 11.97 | 10.28 | 13.67 | 13.18 | 11.77 | 16.31 | 12.23 | 9.82 | 14.64 |
| 9 | 13.47 | 11.22 | 15.72 | 12.68 | 11.25 | 15.02 | 13.87 | 11.22 | 16.52 |
| 10 | 12.20 | 10.69 | 14.02 | 12.79 | 10.23 | 14.28 | 14.30 | 12.62 | 15.98 |

The above method in embodiment 1 is used to sample and detect a batch of 100 mm thin carton trademarks with a hard cover of a brand K. Detection results are as shown in the table below:

Sampling inspection data of 100 mm thin carton trademark with a hard cover of a brand
K (unit: gf)

| Indentation | | | | | | | | |
|---|---|---|---|---|---|---|---|---|
| serial | | | | | | | | |
| number | Sample 1 | Sample 2 | Sample 3 | Sample 4 | Sample 5 | Sample 6 | Sample 7 | Sample 8 |
| 1 | 11.85 | 11.92 | 11.37 | 11.74 | 12.62 | 11.80 | 11.52 | 12.17 |
| 2 | 12.29 | 12.08 | 13.05 | 12.63 | 11.47 | 11.16 | 12.99 | 12.21 |
| 3 | 11.30 | 9.10 | 11.47 | 9.03 | 10.92 | 10.31 | 9.63 | 9.09 |
| 4 | 10.57 | 11.12 | 10.49 | 11.99 | 11.53 | 10.01 | 10.79 | 10.64 |
| 5 | 10.92 | 11.17 | 11.26 | 10.90 | 11.32 | 9.86 | 9.90 | 9.73 |
| 6 | 10.69 | 10.71 | 11.45 | 11.05 | 11.13 | 11.49 | 11.96 | 12.08 |
| 7 | 13.78 | 13.21 | 13.21 | 13.66 | 13.24 | 12.75 | 13.42 | 12.97 |
| 8 | 10.55 | 10.65 | 10.35 | 11.77 | 12.15 | 12.02 | 11.84 | 12.17 |
| 9 | 11.87 | 11.77 | 13.02 | 11.95 | 12.22 | 11.51 | 12.10 | 11.70 |
| 10 | 12.41 | 12.63 | 11.80 | 13.14 | 12.52 | 11.98 | 11.73 | 12.45 |

Indentation 2 and 9 are in the gluing position. If they are not folded properly, the gluing is not strong. 4, 5, 6, and 7 are in the critical positions of the carton forming. If they are not folded properly, defects such as the exposed lid and inconsistent upper and lower widths appear after the cigarette pack is formed. Therefore, the indentations 2, 9, 4, 5, 6, and 7 belong to the critical indentation group. The indentations 1, 3, 8, and 10 are short, and their folding positions are relatively fixed and have little impact on the carton forming effect. Therefore, they belong to the non-critical indentation group.

Through data comparison, it can be determined that among the 8 samples measured, only the indentation stiffness of sample 1, sample 3, sample 5, and sample 6 is within the internal control range, and are carton trademarks with qualified indentation stiffness. Stiffness of indentation 3 of sample 2, sample 4, sample 7, and sample 8 exceeds the internal control range, and indentation 3 is a non-critical indentation. Therefore, sample 2, sample 4, sample 7, and sample 8 are carton trademarks with qualified indentation stiffness.

To sum up, all eight samples sampled from this batch of pack trademarks are qualified, with a qualification rate of 100%. Therefore, this batch of carton trademarks is qualified raw materials and are expected to have good machine suitability and can enter the production process. If there are too many trademarks in this batch, the number of samples should be appropriately increased for detection and determination again.

According to the above method, the total internal control range values of the to-be-detected indentation stiffness of pack trademarks and carton trademarks of various specifications regardless of brands are measured, as shown in the table below. Based on the internal control range values, the industry is provided with unified standards and references for detecting the indentation stiffness of trademarks. This practically helps improve the trademark yield rate for the industry as a whole.

Total internal control range value of indentation stiffness of pack trademarks of various specifications (unit: gf)
Total internal control range value of indentation stiffness of 84 mm
hardened standard pack trademark with soft cover (unit: gf)

| Indentation | | | | | | | | | |
|---|---|---|---|---|---|---|---|---|---|
| serial | | | | | | | | | |
| number | 1 | 2 | 3 | 4 | 5 | 6 | 7 | 8 | 9 |
| Minimum | 5.71 | 5.4 | 5.1 | 5.41 | 5.68 | 6.06 | 6.79 | 6.78 | 6.97 |
| internal | | | | | | | | | |
| control | | | | | | | | | |
| value | | | | | | | | | |
| Maximum | 9.76 | 9.43 | 9.84 | 8.53 | 10.13 | 13.36 | 14.64 | 14.09 | 13.15 |
| internal | | | | | | | | | |
| control | | | | | | | | | |
| value | | | | | | | | | |

Total internal control range value of indentation stiffness of 84 mm
hardened standard pack trademark with soft cover (unit: gf)

| Indentation | | | | | | | | | | | | | | | | |
|---|---|---|---|---|---|---|---|---|---|---|---|---|---|---|---|---|
| serial | | | | | | | | | | | | | | | | |
| number | 1 | 2 | 3 | 4 | 5 | 6 | 7 | 8 | 9 | 10 | 11 | 12 | 13 | 11 | 15 | 16 |
| Minimum | 13.33 | 14.34 | 14.43 | 13.51 | 12.51 | 11.67 | 11.59 | 12.36 | 12.5 | 12.49 | 12.18 | 16.3 | 15.23 | 17.04 | 13.16 | 12.31 |
| internal | | | | | | | | | | | | | | | | |
| control | | | | | | | | | | | | | | | | |
| value | | | | | | | | | | | | | | | | |
| Maximum | 22.77 | 22.07 | 23.87 | 19.41 | 23.35 | 18.8 | 20.24 | 22.11 | 18.19 | 21.07 | 20.73 | 24.04 | 23.88 | 25.36 | 22.49 | 22.63 |
| internal | | | | | | | | | | | | | | | | |
| control | | | | | | | | | | | | | | | | |
| value | | | | | | | | | | | | | | | | |
| Minimum | 11.77 | 13.53 | 11.55 | 11.44 | 12.03 | 8.11 | 8.03 | 9.01 | 12.38 | 11.17 | 11.3 | 12.16 | 11.91 | 12.77 | 10.24 | 11.02 |
| internal | | | | | | | | | | | | | | | | |
| control | | | | | | | | | | | | | | | | |
| value | | | | | | | | | | | | | | | | |
| Maximum | 18.49 | 19.99 | 20.69 | 22.98 | 23.49 | 17.02 | 16.47 | 18.6 | 18.24 | 15.06 | 16.91 | 19.69 | 20.99 | 19.37 | 16.9 | 17.8 |
| internal | | | | | | | | | | | | | | | | |
| control | | | | | | | | | | | | | | | | |
| value | | | | | | | | | | | | | | | | |

Total internal control range value of indentation stiffness of 94 mm pack trademark with hard cover (unit: gf)

| Indentation | | | | | | | | | | | | | | | | |
|---|---|---|---|---|---|---|---|---|---|---|---|---|---|---|---|---|
| serial | | | | | | | | | | | | | | | | |
| number | 1 | 2 | 3 | 4 | 5 | 6 | 7 | 8 | 9 | 10 | 11 | 12 | 13 | 14 | 15 | 16 |
| Minimum | 12.42 | 11.9 | 11.66 | 12.42 | 13.35 | 12.09 | 10.29 | 11.38 | 10.64 | 10.92 | 10.97 | 12.5 | 13.61 | 12.54 | 11.78 | 12.5 |
| internal | | | | | | | | | | | | | | | | |
| control | | | | | | | | | | | | | | | | |
| value | | | | | | | | | | | | | | | | |
| Maximum | 20.16 | 20.3 | 23.81 | 18.64 | 19.24 | 19.75 | 23.99 | 22.6 | 20.28 | 23.03 | 18.12 | 19.28 | 18.55 | 19.9 | 22.87 | 24.58 |
| internal | | | | | | | | | | | | | | | | |
| control | | | | | | | | | | | | | | | | |
| value | | | | | | | | | | | | | | | | |

Total internal control range value of indentation stiffness of 100 mm thin pack trademark with a hard cover (unit: gf)

| Indentation | | | | | | | | | | | | | | | | |
|---|---|---|---|---|---|---|---|---|---|---|---|---|---|---|---|---|
| serial | | | | | | | | | | | | | | | | |
| number | 1 | 2 | 3 | 4 | 5 | 6 | 7 | 8 | 9 | 10 | 11 | 12 | 13 | 14 | 15 | 16 |
| Minimum | 10.87 | 14.05 | 13.28 | 10.71 | 11.17 | 10.77 | 10.97 | 10.29 | 10.08 | 10.13 | 10.3 | 13.09 | 12.93 | 12.44 | 11.82 | 12.05 |
| internal | | | | | | | | | | | | | | | | |
| control | | | | | | | | | | | | | | | | |
| value | | | | | | | | | | | | | | | | |
| Maximum | 20.1 | 20.69 | 22.47 | 20.18 | 21.73 | 17.89 | 17.73 | 17.6 | 18.24 | 17.39 | 18.23 | 22.7 | 20.05 | 20.83 | 17.97 | 19.05 |
| internal | | | | | | | | | | | | | | | | |
| control | | | | | | | | | | | | | | | | |
| value | | | | | | | | | | | | | | | | |

Total internal control range value of indentation stiffness of carton trademarks of
various specifications (unit: gf)
Total internal control range value of indentation stiffness of 84 mm hardened standard carton
trademark with soft cover (unit: gf)

| Indentation | | | | | | | | | | |
|---|---|---|---|---|---|---|---|---|---|---|
| serial | | | | | | | | | | |
| number | 1 | 2 | 3 | 4 | 5 | 6 | 7 | 8 | 9 | 10 |
| Minimum | 10.38 | 11.23 | 9.29 | 10.34 | 9.48 | 9.34 | 9.79 | 9.11 | 10.62 | 9.03 |
| internal | | | | | | | | | | |
| control | | | | | | | | | | |
| value | | | | | | | | | | |
| Maximum | 15.42 | 15.65 | 15.98 | 15.9 | 15.45 | 15.99 | 14.11 | 14.48 | 14.36 | 14.46 |
| internal | | | | | | | | | | |
| control | | | | | | | | | | |
| value | | | | | | | | | | |
| Minimum | 10.07 | 9.27 | 10.34 | 9.03 | 10.05 | 10.63 | 9.04 | 9.39 | 9.2 | 9.88 |
| internal | | | | | | | | | | |
| control | | | | | | | | | | |
| value | | | | | | | | | | |
| Maximum | 15.18 | 13.81 | 14.07 | 15.51 | 13.88 | 14.73 | 16 | 15.79 | 15.36 | 14.44 |
| internal | | | | | | | | | | |
| control | | | | | | | | | | |
| value | | | | | | | | | | |
| Minimum | 12.5 | 10.5 | 10.91 | 12.9 | 10.3 | 9.81 | 12.4 | 10.53 | 12.86 | 11.26 |
| internal | | | | | | | | | | |
| control | | | | | | | | | | |
| value | | | | | | | | | | |
| Maximum | 15.08 | 12.08 | 15.39 | 14.36 | 14.44 | 15.05 | 15.22 | 14.64 | 15.21 | 12.35 |
| internal | | | | | | | | | | |
| control | | | | | | | | | | |
| value | | | | | | | | | | |
| Minimum | 9.44 | 9.79 | 10.22 | 9.81 | 9 | 9.26 | 9.56 | 9.07 | 9.79 | 9.44 |
| internal | | | | | | | | | | |
| control | | | | | | | | | | |
| value | | | | | | | | | | |
| Maximum | 15.94 | 15.98 | 14.57 | 15.87 | 12.93 | 14.65 | 15.37 | 14.47 | 15.61 | 14.43 |
| internal | | | | | | | | | | |
| control | | | | | | | | | | |
| value | | | | | | | | | | |
| number | | | | | | | | | | |

Total internal control range value of indentation stiffness of 94 mm medium carton trademark
with hard cover (unit: gf)

| Indentation | | | | | | | | | | |
|---|---|---|---|---|---|---|---|---|---|---|
| serial | | | | | | | | | | |
| number | 1 | 2 | 3 | 4 | 5 | 6 | 7 | 8 | 9 | 10 |
| Minimum | 11.28 | 9.14 | 9.7 | 9.32 | 9.94 | 10.26 | 9.47 | 9.43 | 9.93 | 10.08 |
| internal | | | | | | | | | | |
| control | | | | | | | | | | |
| value | | | | | | | | | | |
| Maximum | 15.35 | 14.57 | 13.26 | 13.97 | 14.98 | 15.54 | 14.27 | 13.6 | 16.54 | 15.94 |
| internal | | | | | | | | | | |
| control | | | | | | | | | | |
| value | | | | | | | | | | |

Total internal control range value of indentation stiffness of 100 mm thin carton trademark
with hard cover (unit: gf)

| Indentation | | | | | | | | | | |
|---|---|---|---|---|---|---|---|---|---|---|
| serial | | | | | | | | | | |
| number | 1 | 2 | 3 | 4 | 5 | 6 | 7 | 8 | 9 | 10 |
| Minimum | 10.57 | 10.12 | 9.7 | 9.72 | 9.01 | 9.51 | 9.26 | 9.82 | 11.22 | 10.23 |
| internal | | | | | | | | | | |
| control | | | | | | | | | | |
| value | | | | | | | | | | |
| Maximum | 16.91 | 15.78 | 13.54 | 13.54 | 15.23 | 15.6 | 15.57 | 16.31 | 16.52 | 15.98 |
| internal | | | | | | | | | | |
| control | | | | | | | | | | |
| value | | | | | | | | | | |

Embodiment 3: Detection and control of the trademark surface friction coefficient include the following steps:

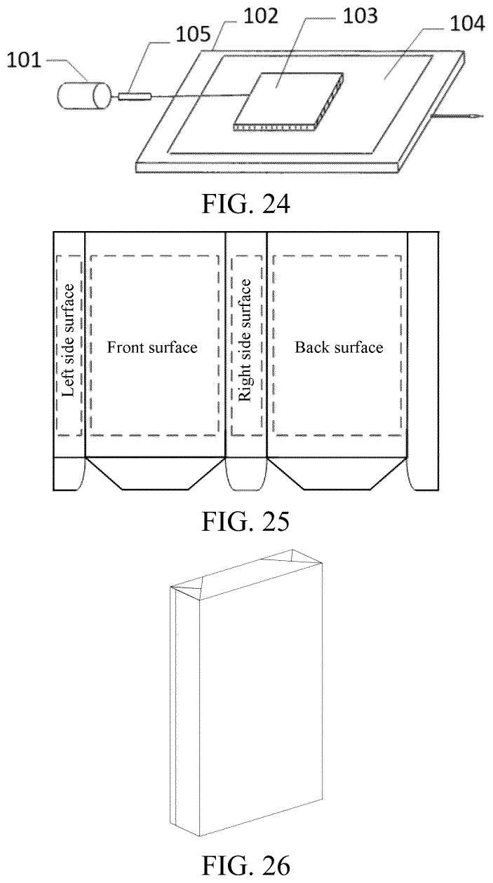

The detection instrument used is a friction coefficient meter, and is mainly configured to measure the static friction coefficient of the material and the dynamic friction coefficient during sliding. The precision can reach 0.01 N. The total error of the entire force measuring system is less than ±2%, and the conversion time does not exceed 0.5 s. The friction coefficient meter is shown in FIG. 23 and FIG. 24, including a sensor 101, a traction rope, a horizontal detection bench 102, a slider 103, and a measuring pad 104. Before detection, the instrument is placed on a stable and vibration-free platform to adjust the level. The instrument measurement stroke is set, and the default value is 100 mm.

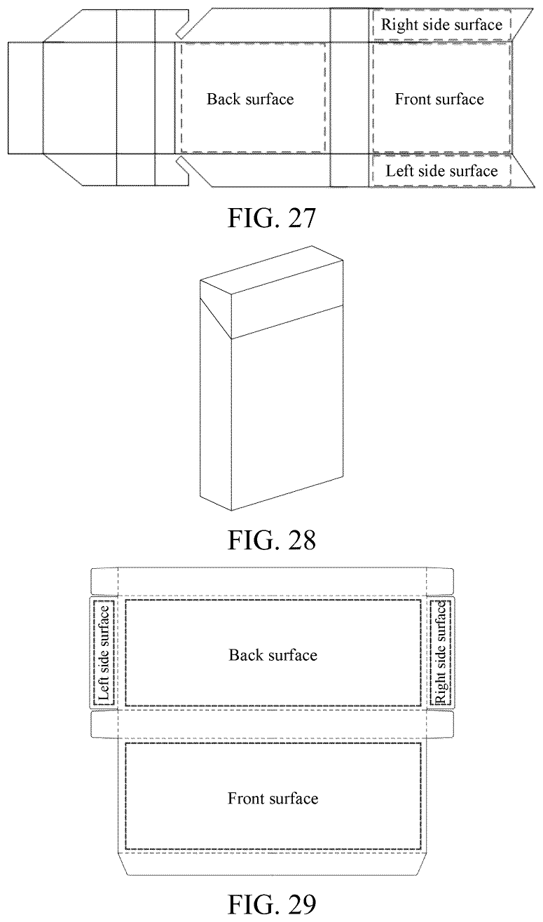

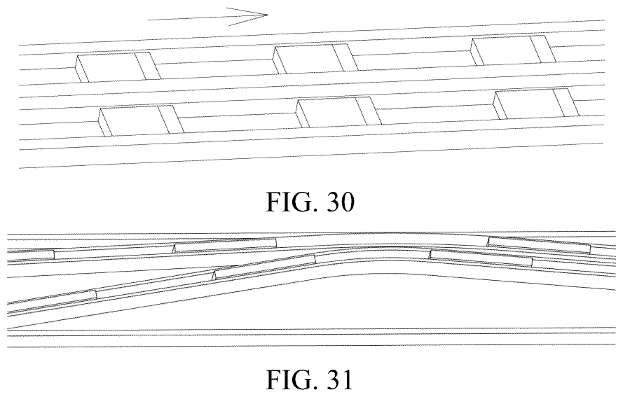

As shown in FIG. 25 and FIG. 27, the pack trademarks that need to be detected are the soft pack trademarks of batch A and the hard pack trademarks of batch B. The two types of pack trademarks are shown in FIG. 26 and FIG. 28 respectively after being folded and formed. Then, the two types of trademarks are packed into packs and transported in the packaging machine, as shown in FIG. 30 and FIG. 31. Therefore, according to the contact surfaces between the two types of trademarks and the conveyor channel after being folded and formed in the packaging machine, as well as the printed pattern surface, the to-be-measured surfaces of the two types of trademarks are divided into a front surface, a back surface, a left side surface, and a right side surface.

Ten samples are randomly selected from each of two different batches of pack trademarks, and then the to-be-measured surfaces are cut. Then, double-sided tape is used to paste the cut-out trademark measurement part on the bottom surface of the slider 103 of the corresponding size. For the front surface and the back surface of the pack trademark, a large slider with a square bottom surface of 63 mm×63 mm and a weight of 1.949 N is used. For the left side surface and the right side surface of the pack trademark, a small slider with a rectangular bottom surface of 19 mm×49 mm and a weight of 0.725 N is used. The cut size should be the same as the size of the bottom surface of the slider 103. The sample should be kept flat and wrinkle-free, and there should be no scratches or wrinkles on the surface that would affect the measurement results, to ensure that the cutting edge of the sample is smooth, and the surface of the sample is free of dust and fingerprints.

Before starting the measurement, if the force value of the sensor 101 is not zero when no force is applied, zero adjustment is performed first.

An A4 paper is flatly placed on a horizontal detection bench 102, the measuring surface of the sample is placed on the A4 paper downwards without impact, and a traction rope is hung to a hook of the sensor 101, so that the traction rope is in a horizontal and straight state, and the edge of the sample is parallel to the edge of the detection bench. As shown in FIG. 23, when measuring static friction, the soft connection traction rope 106 is used, and as shown in FIG. 24, when measuring dynamic friction, the hard connection traction rope 105 is used.

After the sample is in contact with the A4 paper for 15 seconds, the “detection” button of the friction coefficient meter is pressed. The sample is affected by the gravity of the slider 103, and the surface of the sample and the surface of the A4 paper move relative to each other. The measured force value is saved and displayed on the display. The “return” key is pressed after the measurement is completed to return the detection bench to the starting position. After detecting all frictions, the static friction and dynamic friction are both divided by the normal force respectively to obtain the static friction coefficient and the dynamic friction coefficient.

The detection results of two different batches of samples are shown in the following table:

Detection results of friction coefficients of soft pack
trademarks of batch A

| | | | | | Left side | | Right side | |
|---|---|---|---|---|---|---|---|---|
| | Front surface | | Back | surface | surface | | surface | |
| | Static | Dy- | Static | Dy- | Static | Dy- | Static | Dy- |
| Batch | fric- | namic | fric- | namic | fric- | namic | fric- | namic |
| A | tion | friction | tion | friction | tion | friction | tion | friction |
| 1 | 0.23 | 0.20 | 0.27 | 0.25 | 0.30 | 0.14 | 0.30 | 0.16 |
| 2 | 0.25 | 0.21 | 0.27 | 0.25 | 0.31 | 0.15 | 0.32 | 0.16 |
| 3 | 0.30 | 0.26 | 0.28 | 0.25 | 0.33 | 0.16 | 0.29 | 0.15 |
| 4 | 0.26 | 0.21 | 0.29 | 0.26 | 0.36 | 0.16 | 0.32 | 0.16 |
| 5 | 0.28 | 0.26 | 0.28 | 0.27 | 0.35 | 0.16 | 0.31 | 0.16 |
| 6 | 0.27 | 0.24 | 0.26 | 0.25 | 0.33 | 0.15 | 0.30 | 0.16 |
| 7 | 0.24 | 0.20 | 0.28 | 0.26 | 0.35 | 0.15 | 0.33 | 0.17 |
| 8 | 0.19 | 0.15 | 0.23 | 0.21 | 0.25 | 0.11 | 0.25 | 0.12 |
| 9 | 0.26 | 0.23 | 0.33 | 0.28 | 0.32 | 0.16 | 0.30 | 0.16 |
| 10 | 0.28 | 0.23 | 0.27 | 0.25 | 0.30 | 0.13 | 0.29 | 0.16 |

Detection results of friction coefficients of hard pack
trademarks of batch B

| | Front | | Back | | Left side | | Right side | |
|---|---|---|---|---|---|---|---|---|
| | surface | | surface | | surface | | surface | |
| | Static | Dy- | Static | Dy- | Static | Dy- | Static | Dy- |
| Batch | fric- | namic | fric- | namic | fric- | namic | fric- | namic |
| B | tion | friction | tion | friction | tion | friction | tion | friction |
| 1 | 0.29 | 0.15 | 0.25 | 0.16 | 0.23 | 0.16 | 0.28 | 0.16 |
| 2 | 0.26 | 0.16 | 0.23 | 0.17 | 0.26 | 0.18 | 0.24 | 0.19 |
| 3 | 0.27 | 0.19 | 0.26 | 0.15 | 0.24 | 0.20 | 0.29 | 0.20 |
| 4 | 0.29 | 0.16 | 0.24 | 0.19 | 0.28 | 0.23 | 0.31 | 0.16 |
| 5 | 0.25 | 0.18 | 0.26 | 0.22 | 0.22 | 0.18 | 0.33 | 0.18 |
| 6 | 0.33 | 0.21 | 0.25 | 0.18 | 0.31 | 0.25 | 0.25 | 0.17 |
| 7 | 0.30 | 0.18 | 0.28 | 0.15 | 0.26 | 0.18 | 0.21 | 0.12 |
| 8 | 0.28 | 0.17 | 0.22 | 0.16 | 0.29 | 0.16 | 0.25 | 0.19 |
| 9 | 0.35 | 0.18 | 0.26 | 0.18 | 0.25 | 0.18 | 0.29 | 0.18 |
| 10 | 0.30 | 0.18 | 0.24 | 0.21 | 0.26 | 0.13 | 0.30 | 0.20 |

For the pack trademarks corresponding to batches A and B, a batch of pack trademarks that does not have any quality problems within a period of time is sampled, and a friction coefficient of each to-be-detected surface of the sampled batch of pack trademarks is measured and an average value is obtained, where the average value is a standard value of the friction coefficient, a measurement value that deviates from the average value by more than twice the standard deviation is removed, the remaining minimum value and maximum value are the upper limit and lower limit of the internal control interval, and the interval between the final upper limit and lower limit is the internal control range. The internal control value ranges of the soft trademark friction coefficient and the hard trademark friction coefficient corresponding to batches A and B are shown in the following table:

Internal control value of friction coefficient of soft pack trademark

| | | Average | Minimum | Maximum |
|---|---|---|---|---|
| | | internal | internal | internal |
| Detection | | control | control | control |
| surface | Item | value | value | value |
| Front | Static friction | 0.26 | 0.21 | 0.33 |
| surface | Dynamic friction | 0.25 | 0.20 | 0.28 |
| Back | Static friction | 0.28 | 0.26 | 0.31 |
| surface | Dynamic friction | 0.27 | 0.25 | 0.29 |
| Left side | Static friction | 0.35 | 0.30 | 0.41 |
| surface | Dynamic friction | 0.16 | 0.13 | 0.17 |
| Right side | Static friction | 0.33 | 0.27 | 0.35 |
| surface | Dynamic friction | 0.18 | 0.14 | 0.20 |

Internal control value of friction coefficient of hard pack trademark

| | | Average | Minimum | Maximum |
|---|---|---|---|---|
| | | internal | internal | internal |
| Detection | | control | control | control |
| surface | Item | value | value | value |
| Front | Static friction | 0.29 | 0.26 | 0.33 |
| surface | Dynamic friction | 0.17 | 0.15 | 0.19 |
| Back | Static friction | 0.23 | 0.20 | 0.27 |
| surface | Dynamic friction | 0.17 | 0.15 | 0.18 |
| Left side | Static friction | 0.24 | 0.21 | 0.33 |
| surface | Dynamic friction | 0.15 | 0.10 | 0.21 |
| Right side | Static friction | 0.30 | 0.26 | 0.32 |
| surface | Dynamic friction | 0.18 | 0.14 | 0.21 |

Through the analysis of the measurement results, it is concluded that the dynamic and static friction coefficients of the four detection surfaces of sample 8 of the soft pack trademark of batch A are not within the internal control value, and the number of unqualified samples accounts for 10%. Therefore, it is determined that the soft pack trademarks of batch A are unqualified. If there are too many trademarks in this batch, the number of samples should be appropriately increased and detected again. Although samples 2, 5, 6, 7, and 9 of hard pack trademarks of batch B have detection surface friction coefficients that are not within the internal control value, at least one of the front surface and back surface is within the internal control value, and at the same time, at least one of the left side surface and the right side surface is within the internal control value. Therefore, it is determined that the hard pack trademarks of batch B are qualified.

As shown in FIG. 29, the to-be-detected surfaces of the carton trademarks of batch C are divided into a front surface, a back surface, a left side surface, and a right side surface. According to the above detection method, ten samples of the carton trademarks of batch C are selected for detection. The sample detection results are as shown in the following table:

Detection results of friction coefficients of carton trademarks
of batch C

| | Front | | Back | | Left side | | Right side | |
|---|---|---|---|---|---|---|---|---|
| | surface | | surface | | surface | | surface | |
| | | Dy- | | Dy- | | Dy- | | Dy- |
| | Static | namic | Static | namic | Static | namic | Static | namic |
| Batch | fric- | fric- | fric- | fric- | fric- | fric- | fric- | fric- |
| C | tion | tion | tion | tion | tion | tion | tion | tion |
| 1 | 0.35 | 0.28 | 0.34 | 0.28 | 0.33 | 0.23 | 0.31 | 0.25 |
| 2 | 0.35 | 0.28 | 0.36 | 0.32 | 0.32 | 0.22 | 0.34 | 0.26 |
| 3 | 0.34 | 0.25 | 0.37 | 0.25 | 0.27 | 0.22 | 0.28 | 0.22 |
| 4 | 0.35 | 0.24 | 0.35 | 0.24 | 0.28 | 0.23 | 0.28 | 0.22 |
| 5 | 0.33 | 0.26 | 0.38 | 0.21 | 0.27 | 0.22 | 0.3 | 0.24 |
| 6 | 0.29 | 0.24 | 0.35 | 0.27 | 0.33 | 0.25 | 0.27 | 0.22 |
| 7 | 0.32 | 0.25 | 0.34 | 0.21 | 0.28 | 0.23 | 0.31 | 0.23 |
| 8 | 0.29 | 0.23 | 0.34 | 0.23 | 0.3 | 0.26 | 0.34 | 0.25 |
| 9 | 0.29 | 0.23 | 0.33 | 0.24 | 0.27 | 0.22 | 0.34 | 0.25 |
| 10 | 0.32 | 0.27 | 0.32 | 0.26 | 0.27 | 0.23 | 0.3 | 0.23 |

For the carton trademarks corresponding to batch C, a batch of carton trademarks that does not have any quality problems within a period of time is sampled, and a friction coefficient of each to-be-detected surface of the sampled batch of carton trademarks is measured and an average value is obtained, where the average value is a standard value of the friction coefficient, a measurement value that deviates from the average value by more than twice the standard deviation is removed, the remaining minimum value and maximum value are the upper limit and lower limit of the internal control interval, and the interval between the final upper limit and lower limit is the internal control range. The internal control value range of the friction coefficient of carton trademarks corresponding to batch C is as follows:

Internal control value of friction coefficient of carton trademark

| | | Average | Minimum | Maximum |
|---|---|---|---|---|
| | | internal | internal | internal |
| Detection | | control | control | control |
| surface | Item | value | value | value |
| Front | Static friction | 0.32 | 0.27 | 0.37 |
| surface | Dynamic | 0.26 | 0.23 | 0.28 |
| | friction | | | |
| Back | Static friction | 0.34 | 0.31 | 0.37 |
| surface | Dynamic | 0.25 | 0.22 | 0.28 |
| | friction | | | |
| Left side | Static friction | 0.33 | 0.27 | 0.35 |
| surface | Dynamic | 0.25 | 0.22 | 0.27 |
| | friction | | | |
| Right side | Static friction | 0.30 | 0.27 | 0.34 |
| surface | Dynamic | 0.24 | 0.22 | 0.26 |
| | friction | | | |

Although samples 2, 5, and 7 of carton trademarks of batch C have detection surface friction coefficients that are not within the internal control value, at least one of the front surface and back surface is within the internal control value, and at the same time, at least one of the left side surface and the right side surface is within the internal control value. Therefore, it is determined that the carton trademarks of batch C are qualified.

Embodiment 4: In embodiment 1 to embodiment 3, only batches of raw materials of samples whose detection results of the quality detection and control of the trademark gluing position, the detection and control of the trademark indentation stiffness, and the detection and control of the trademark surface friction coefficient are all determined to be qualified can enter the production process; otherwise, they are eliminated.

Qualified trademarks enter the packaging machine for production, and the conveying efficiency of the packaging machine reaches about 500 sheets per minute, indicating that the residence time of trademark paper in all stages of the packaging machine is normal. After a series of indicator control on trademarks, the overall defect rate drops by about 51.72% in a single day; and the defect rate caused by unqualified trademarks decreases by about 32.32%, which effectively reduces the defect rate of finished products, saves a series of supporting materials, and improves production efficiency.

It should be understood that the above-described specific embodiments of the present invention are only used to illustrate or explain the principles of the present invention, and do not constitute a limitation of the present invention. Therefore, any modifications, equivalent substitutions, improvements, or the like made without departing from the spirit and scope of the present invention should be included in the protection scope of the present invention. For example, for food packaging boxes, beverage packaging boxes, and gift packaging boxes, the method described in the present invention can be used to detect the size of the raw materials before the box is formed, so as to achieve the purpose of screening raw materials and reducing the defect rate of finished products. Furthermore, it is intended that the appended claims of the present invention cover all changes and modifications that fall within the scope and boundaries of the appended claims, or equivalents of such scopes and boundaries.

What is claimed is:

1. A qualification rate increasing method for finished products based on trademark parameter detection and control, comprising:
quality detection and control of a trademark gluing position, detection and control of trademark indentation stiffness, and detection and control of a trademark surface friction coefficient; wherein
the quality detection and control of the trademark gluing position comprises pretreatment of a trademark gluing region and detection of trademark moisture adsorption and desorption capacity; and
when detecting trademark parameters, samples are taken from a same batch of trademarks, and the samples are evenly distributed and used to detect the trademark indentation stiffness, the trademark moisture adsorption and desorption capacity, and the trademark surface friction coefficient; only a batch of trademarks of samples whose three detection results are all determined to be qualified can enter a production process; otherwise, this batch of trademarks are eliminated.

2. The qualification rate increasing method for finished products based on trademark parameter detection and control according to claim 1, wherein the trademark comprises a pack trademark and a carton trademark; and the quality detection and control of the trademark gluing position comprises following steps:
S1: dividing the gluing region: dividing the trademark gluing region into a non-print surface gluing region and a print surface gluing region;
S2: pretreatment: pretreating the print surface gluing region to form a surface that is easy to absorb glue;
S3: detecting moisture adsorption and desorption capacity: separately detecting moisture adsorption and desorption capacity of the non-print surface gluing region and the print surface gluing region of the sample trademark; and
S4: performing quality determination: comparing detection data with an internal control range to determine whether the moisture adsorption and desorption capacity of a selected sample is qualified, and determining, based on a determination result, whether the moisture adsorption and desorption capacity of the gluing region of this batch of trademarks is qualified.

3. The qualification rate increasing method for finished products based on trademark parameter detection and control according to claim 2, wherein the pretreatment of step S2 comprises indentation treatment or scraping treatment of the print surface gluing region, so that an original smooth print surface gluing region forms an uneven surface to facilitate glue absorption;
the indentation treatment comprises forming indentation lines or indentation points in the print surface gluing region, the scraping treatment comprises destroying the smooth surface of the print surface gluing region to form a hairy surface, and
when performing indentation treatment or scraping treatment, the indentation line or indentation point or scraping density of a region close to a folding indentation position in the print surface gluing region is greater than that of other regions.

4. The qualification rate increasing method for finished products based on trademark parameter detection and control according to claim 2, wherein the step S3 of detecting moisture adsorption and desorption capacity comprises following steps:
S3.1: sampling: selecting samples from a batch of to-be-detected trademarks, cutting and sampling non-print surface gluing regions and print surface gluing regions on the selected sample trademarks, to cut a to-be-detected part into 40 mm*40 mm samples, and placing the samples on a sample tray of a moisture adsorption and desorption detector, wherein a weight of the sample in each sample tray is controlled between 1.5 g and 3.5 g;
S3.2: performing stage treatment: performing stage treatment on the sample in the sample tray through the moisture adsorption and desorption detector; wherein the stage comprises an equilibrium stage, a moisture absorption stage, and a dehumidification stage; and recording a mass of the sample at an end of each stage; and
S3.3: performing calculation: according to the recorded mass of the sample at the end of each stage, calculating sample mass change rates in the moisture absorption stage and dehumidification stage respectively, and using the results to represent a moisture absorption rate and a dehumidification rate of the sample respectively; wherein
in step S3.2, parameter values for the equilibrium stage are set to temperature 24° C., humidity 60%, and treatment time of 5 minutes; parameter values for the moisture absorption stage are set to temperature 24° C., humidity 90%, and treatment time of 60 minutes; and parameter values of the dehumidification stage are set to temperature 24° C., humidity 60%, and treatment time of 60 minutes;
in step S3.1, when the sampled region comprises two types of gluing regions at a same time, sampling is performed according to the print surface gluing region; and
in step S4, when the moisture adsorption or desorption capacity of the sample trademark is unqualified in detection data of the non-print surface gluing region or the print surface gluing region of the selected sample trademark, it is determined that the moisture adsorption and desorption capacity of the sample trademark is unqualified; and when a defect rate of moisture adsorption and desorption capacity of a single sample of detection samples in this batch of trademarks accounts for 10% or more, it is determined that this batch of trademarks is unqualified.

5. The qualification rate increasing method for finished products based on trademark parameter detection and control according to claim 1, wherein the trademark comprises a pack trademark and a carton trademark; and the detection of trademark indentation stiffness comprises following steps:
S1: establishing a to-be-detected indentation database: classifying the trademarks according to trademark size data of each specification and a process of packaging the trademarks into packs in a packaging machine; determining to-be-detected indentations on each category of trademarks and an internal control range of each to-be-detected indentation, and establishing a to-be-detected indentation database;
S2: sampling: cutting and sampling the to-be-detected indentation of a selected sample according to a specification of the batch of trademarks of the sample;
S3: performing stiffness detection: using a bending stiffness meter to detect stiffness of a selected indentation sample, comparing measured stiffness data with the internal control range, and determining whether the stiffness of the sample trademark indentation is qualified based on a comparison result; and
S4: performing quality determination: comparing based on the indentation stiffness measurement result of the sample trademark to determine whether the batch of trademarks of the sample meets a production requirement.

6. The qualification rate increasing method for finished products based on trademark parameter detection and control according to claim 5, wherein when the to-be-detected indentation is sampled in step S2, a sample shape of a part cut from the indentation is a rectangle, the rectangle is divided into a bending length part and a clamping depth part with the part cut from the indentation as a boundary;
the bending length part is a square with the part cut from the indentation as one side, the clamping depth part is a rectangle with the part cut from the indentation as a short side, a length ratio of a long side to the short side of the clamping depth part is two to one;
when sampling the to-be-detected indentation in step S2, a region where a midpoint of the indentation is located is selected;
if two indentations are too close to each other or sampling regions where the midpoints of the indentations are located at a same time causes overlap and conflict in sampling parts, regions where points in one-third positions at opposite ends of the two close indentations are located are respectively selected; and
a length of the part cut when sampling the to-be-detected indentation is 6 mm.

7. The qualification rate increasing method for finished products based on trademark parameter detection and control according to claim 5, wherein in step S4, all indentations are divided into a critical indentation group and a non-critical indentation group, indentations at gluing and folding positions and indentations at critical folding positions for cigarette pack forming belong to the critical indentation group, remaining indentations belong to the non-critical indentation group,
if the critical indentation group comprises an indentation with stiffness exceeding an internal control range, it is determined that the trademark indentation stiffness quality fails, and
if the non-critical indentation group comprises more than two indentations with stiffness exceeding the internal control range, it is determined that the trademark indentation stiffness quality fails.

8. The qualification rate increasing method for finished products based on trademark parameter detection and control according to claim 1, wherein the trademark comprises a pack trademark and a carton trademark; and the detection of the trademark surface friction coefficient comprises following steps:
S1: determining a friction surface: according to contact with a packaging machine when the trademark is folded and passes through a packaging machine channel, dividing the trademark into a front surface, a back surface, a left side surface, and a right side surface;
S2: sampling: cutting the sample according to a to-be-detected surface;
S3: measuring a friction coefficient: using a friction coefficient meter to measure friction coefficients of the front surface, the back surface, the left side surface, and the right side surface of the sample trademark respectively; wherein the friction coefficient comprises a static friction coefficient and a dynamic friction coefficient;
S4: comparing measurement results: comparing the detected friction coefficient with an internal control value to determine whether the sample friction coefficient meets a requirement; and
S5: performing quality determination: comparing based on the measurement result of the sample to determine whether the batch of trademarks of the sample meets a production requirement.

9. The qualification rate increasing method for finished products based on trademark parameter detection and control according to claim 8, wherein the step S3 of measuring the friction coefficient comprises following steps:
A: leveling: placing an instrument on a stable and vibration-free platform to adjust the level;
B: setting a slider (103) weight: setting the slider (103) weight on the instrument;
C: performing stroke setting: setting an instrument measurement stroke, wherein a default is 100 mm;
D: making a sample: pasting a cut-out trademark measurement part on a bottom surface of the slider (103), wherein a cut size is consistent with the size of the bottom surface of the slider (103);
E: performing detection zero adjustment: before starting the measurement, performing zero adjustment;
F: making sample preparation: fixing a measuring pad (104) flatly on a horizontal detection bench (102), placing the measuring surface of the sample on the measuring pad (104) downwards without impact, and hanging a traction rope to a sensor (101) hook, so that the traction rope is in a horizontal and straight state, and an edge of the sample is parallel to the edge of the detection bench;
G: performing measurement: starting measuring after the sample is in contact with the measuring pad (104) for 15 seconds, and measuring a dynamic friction and a static friction of the measurement sample respectively; and
H: performing calculation: dividing the measured static friction and dynamic friction by a normal force respectively to obtain the static friction coefficient and the dynamic friction coefficient; wherein
the traction rope comprises a soft connection traction rope (106) and a hard connection traction rope (105), a spring is provided in a middle of the soft connection traction rope (106), when measuring static friction, the soft connection traction rope (106) is used, and when measuring dynamic friction, the hard connection traction rope (105) is used; and
in step S4, if the detected friction coefficient of at least one of the front surface and the back surface of the sample is within the internal control value, and at least one of the left side surface and the right side surface is within the internal control value, it is determined that the friction coefficient of the sample meets the requirement; otherwise, it does not meet the requirement.

10. The qualification rate increasing method for finished products based on trademark parameter detection and control according to claim 9, wherein in step B, different measuring sliders (103) are used for different measurement surfaces of the trademark,
when measuring the friction coefficient of the front surface or the back surface of the trademark, a large slider with a square bottom surface of 63 mm×63 mm and a weight of 1.949 N is used;
when measuring the friction coefficient of the left side surface or the right side surface of the trademark, a small slider with a rectangular bottom surface of 19 mm×49 mm and a weight of 0.725 N is used;
an ordinary A4 paper is selected as the measuring pad (104) in step F, and a same batch of A4 papers is used to measure the same batch of trademarks,
wherein each A4 paper is used for only one-time detection, and a new unused A4 paper needs to be used for each detection.

11. The qualification rate increasing method for finished products based on trademark parameter detection and control according to claim 1, wherein samples selected to detect the indentation stiffness and the moisture adsorption and desorption capacity of the trademark are placed in an environment with a temperature of 22° C.±1° C. and a relative humidity of 60%±5% for twenty-four hours before the detection.
